(19) United States
(12) Patent Application Publication
(10) Pub. No.: US 2024/0396692 A1
(43) Pub. Date: Nov. 28, 2024

(54) FRAMEWORK FOR SIMULTANEOUS MULTI-PANEL UPLINK TRANSMISSION

(71) Applicant: Telefonaktiebolaget LM Ericsson (publ), Stockholm (SE)

(72) Inventors: Andreas NILSSON, Göteborg (SE); Siva MURUGANATHAN, Stittsville (CA); Shiwei GAO, Nepean (CA)

(21) Appl. No.: 18/688,057

(22) PCT Filed: Sep. 1, 2022
(86) PCT No.: PCT/IB2022/058230

§ 371 Date: Feb. 29, 2024

Related U.S. Application Data
(60) Provisional application No. 63/240,746, filed on Sep. 3, 2021.

(51) Int. Cl. H04L 5/00

(52) U.S. Cl. CPC H04L 5/0053; H04L 5/0035; H04L 5/0051

(57) ABSTRACT

A method, network node and wireless device (WD) providing a framework for simultaneous multi-panel uplink (UL) transmission are disclosed. According to one aspect, a method in a network node includes configuring the WD with at least two transmission configuration indicator (TCI) states. The method also includes transmitting downlink control information (DCI) comprising an indication of a first TCI state and a second TCI state to be activated by the WD. The method also includes receiving a first physical uplink shared channel (PUSCH) transmission occasion or a first set of PUSCH layers transmitted using a first spatial filter associated with the first TCI state. The method also includes receiving a second PUSCH transmission occasion or a second set of PUSCH layers transmitted using a second spatial filter associated with the second TCI state.

### TECHNICAL FIELD

The present disclosure relates to wireless communications, and in particular, to a framework for simultaneous multi-panel uplink (UL) transmission.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

Wireless communication systems according to the 3GPP may include the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

In NR, several signals can be transmitted from different antenna ports of the same base station. These signals can have the same large-scale properties such as Doppler shift/spread, average delay spread, or average delay. These antenna ports are then said to be quasi co-located (QCL).

If the WD knows that two antenna ports are QCL with respect to a certain parameter (e.g., Doppler spread), then the WD can estimate that parameter based on a signal received at one of the antenna ports and apply that estimate for receiving a signal on the other antenna port.

For example, there may be a quasi-colocation relationship between a channel state information reference signal (CSI-RS) for tracking (TRS) and the PDSCH demodulation reference signal (DMRS). When the WD receives the PDSCH DMRS, the WD can use the measurements already made on the TRS to assist the DMRS reception.

Information about what assumptions can be made regarding QCL is signaled to the WD from the network. In NR, four types of QCL relationships between a transmitted source RS and transmitted target RS have been defined:
Type A: {Doppler shift, Doppler spread, average delay, delay spread};
Type B: {Doppler shift, Doppler spread};
Type C: {average delay, Doppler shift}; and
Type D: {Spatial receive (Rx) parameter}.

QCL type D was introduced to facilitate beam management with analog beamforming and is known as spatial QCL. There is currently no strict definition of spatial QCL, but an understanding is that if two transmitted antenna ports are spatially QCL, the WD can use the same receive beam to receive the signals at each antenna port. This is helpful for a WD that uses analog beamforming to receive signals, since the WD adjusts its RX beam in some direction prior to receiving a certain signal. If the WD knows that the signal is spatially QCL with some other signal it has received earlier, then it can safely use the same RX beam to receive the signal later. Note that for beam management, the discussion mostly revolves around QCL Type D. However, a Type A QCL relationship for the reference signals sent to the WD must also be conveyed so that the WD and/or base station can estimate all the relevant large-scale parameters.

Typically, this is achieved by configuring the WD with a CSI-RS for tracking (TRS) for time and frequency offset estimation. To be able to use any QCL reference signal, the WD must receive the reference signal with a sufficiently good signal to interference plus noise ratio (SINR). In many cases, this means that the TRS must be transmitted in a suitable beam to a certain WD.

To introduce dynamics in beam and transmission point (TRP) selection, the WD can be configured through radio resource control (RRC) signaling with up to 128 TCI (Transmission Configuration Indicator) states. The TCI state information element is as follows:

| | |
|---|---|
| TCI-State ::= | SEQUENCE { |
| tci-StateId | TCI-StateId, |
| qcl-Type1 | QCL-Info, |
| qcl-Type2 | QCL-Info |
| . . . | |
| } | |
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| . . . | |
| } | |

Each TCI state contains QCL information related to one or two reference signals (RSs). For example, a TCI state may contain CSI-RS1 associated with QCL Type A and CSI-RS2 associated with QCL TypeD. If a third RS, e.g., the PDCCH DMRS, has this TCI state as QCL source, it means that the WD can derive Doppler shift, Doppler spread, average delay, delay spread from CSI-RS1 and Spatial Rx parameter (i.e., the RX beam to use) from CSI-RS2 when performing the channel estimation for the PDCCH DMRS.

A first list of available TCI states is configured for PDSCH, and a second list of TCI states is configured for PDCCH. Each TCI state contains a pointer, known as TCI State ID, which points to the TCI state. The network then activates one TCI state for PDCCH (i.e. provides a TCI for PDCCH) and up to eight TCI states for PDSCH, via a medium access control (MAC) control element (CE). The number of active TCI states the WD support is a WD capability, but the maximum is 8.

For example, assume that a WD has 4 activated TCI states from a list of 64 total configured TCI states, with 60 TCI states being inactive for this particular WD. The WD does not need to estimate or receive estimations of large scale parameters for the inactive TCI states. But the WD continuously tracks and updates the large scale parameters for the RSs in the 4 active TCI states. When scheduling a PDSCH to a WD, the downlink control information (DCI) contains a pointer to one activated TCI state. The WD then knows which large scale parameter estimate to use when performing PDSCH DMRS channel estimation and thus, PDSCH demodulation.

As long as the WD can use any of the currently activated TCI states, DCI signaling is sufficient for pointing to one activated TCI state. However, at some point in time, none of the source reference signals in the currently activated TCI states can be received by the WD. This might occur, for example, when the WD moves out of the beams in which the source RSs in the activated TCI states are transmitted. When this happens (or actually before this happens), the base station (gNB) would have to activate new TCI states. Typically, since the number of activated TCI states is fixed, the network node (e.g., gNB) would also have to deactivate one or more of the currently activated TCI states.

An example of the two-step procedure related to TCI state update is depicted in FIG. 1.

### TCI States Activation/Deactivation for WD-Specific PDSCH Via MAC CE

The details of the MAC CE signaling that is used to activate/deactivate TCI states for WD specific PDSCH are described with reference to FIG. 2, which shows the structure of the MAC CE for activating/deactivating TCI states for WD specific PDSCH.

As shown in FIG. 2, the MAC CE contains the following fields:
Serving Cell ID: This field indicates the identity of the Serving Cell for which the MAC CE applies. The length of the field is 5 bits;
Bandwidth Part (BWP) ID: This field contains the ID corresponding to a downlink bandwidth part for which the MAC CE applies. The BWP ID is given by the higher layer parameter BWP-Id as specified in 3GPP Technical Standard (TS) 38.331. The length of the BWP ID field is 2 bits since a WD can be configured with up to 4 BWPs for DL;
A variable number of fields, Ti: If the WD is configured with a TCI state with TCI State ID i, then the field Ti indicates the activation/deactivation status of the TCI state with TCI State ID i. If the WD is not configured with a TCI state with TCI State ID i, the MAC entity shall ignore the Ti field. The Ti field is set to “1” to indicate that the TCI state with TCI State ID i is to be activated and mapped to a codepoint of the DCI Transmission Configuration Indication field, as specified in 3GPP TS 38.214/38.321. The Ti field is set to “0” to indicate that the TCI state with TCI State ID i shall be deactivated and is not mapped to any codepoint of the DCI TCI field. It should be noted that the codepoint to which the TCI State is mapped is determined by the ordinal position among all the TCI States with Ti field set to “1”. That is the first TCI State with Ti field set to “1” shall be mapped to the codepoint value 0 of the DCI TCI field, the second TCI State with Ti field set to “1” shall be mapped to the codepoint value 1 of the DCI TCI field, and so on. In 3GPP NR Release 15 (3GPP Rel-15), the maximum number of activated TCI states is 8;
A Reserved bit R: this bit is set to ‘0’ in 3GPP NR Rel-15.
Note that a TCI State Activation/Deactivation for a WD-specific PDSCH MAC CE is identified by a MAC PDU subheader with logical channel ID (LCID) as specified in Table 6.2.1-1 of 3GPP TS 38.321. The MAC CE for Activation/Deactivation of TCI States for WD-specific PDSCH has variable size.

### TCI State Indication for WD-Specific PDSCH Via DCI

The network node can use DCI format 1_1 or 1_2 to indicate to the WD that it shall use one of the activated TCI states for the subsequent PDSCH reception. The field being used in the DCI is the TCI field, which is 3 bits if tci-PresentInDCI is “enabled” or tci-PresentForDCI-Format1-2-r16 is present for DCI format 1_1 and DCI 1_2, respectively, by higher layer. One example of such a DCI indication is depicted in FIG. 3.

DCI code point 0 indicates the first TCI state index in the list of TCI states, DCI code point 1 indicates the second TCI state index in the list, and so on.

### Multi-TRP TCI State Operation

In 3GPP Rel-16, a multi-TRP (multiple-transmission reception point) operation was specified and it has two modes of operation, single DCI based multi-TRP and multiple DCI based multi-TRP.

In 3GPP Rel-16, multiple DCI scheduling is for multi-TRP in which a WD may receive two DCIs each scheduling a PDSCH/PUSCH. The two DCIs (carried by respective PDCCHs which scheduled respective PDSCH) are transmitted from the same TRP.

For multi-DCI multi-TRP operation, a WD should be configured with two control resource set (CORESET) pools, each associated with a TRP. Each CORESET pool is a collection of CORESETs that belongs to the same CORESET pool. A CORESET pool index can be configured in each CORESET with a value of 0 or 1.

The two DCIs in the above example are transmitted via respective PDCCHs in two CORESETs belonging to different CORESET pools (i.e. with CORESETPoolIndex 0 and 1 respectively). For each CORESET Pool, the same TCI state operation method in terms of activation/deactivation/indication as described above is assumed.

The other multi-TRP mode, single DCI based multi-TRP, needs two DL TCI states to be associated to one DCI codepoint. That is, when a TCI field codepoint in DCI indicates two TCI states, each TCI state corresponding to a different beam or different TRP. The activation and mapping of 2 TCI states for a codepoint in the TCI field of DCI is done with the below MAC CE from 3GPP TS 38.321, as shown in the example of FIG. 4.

### Enhanced TCI States Activation/Deactivation for WD-Specific PDSCH MAC CE

The Enhanced TCI States Activation/Deactivation for WD-specific PDSCH MAC CE is identified by a MAC PDU subheader with eLCID as specified in 3GPP TS 38.321, Table 6.2.1-1b. It has a variable size consisting of following fields:
Serving Cell ID: This field indicates the identity of the Serving Cell for which the MAC CE applies. The length of the field is 5 bits;
BWP ID: This field indicates a DL BWP for which the MAC CE applies the codepoint of the DCI bandwidth part indicator field as specified in 3GPP TS 38.212 [9]. The length of the BWP ID field is 2 bits;
Cᵢ: This field indicates whether the octet containing TCI state ID_{i,2} is present. If this field is set to “1”, the octet containing TCI state ID_{i,2} is present. If this field is set to “0”, the octet containing TCI state ID_{i,2} is not present;
TCI state ID_{i,j}: This field indicates the TCI state identified by TCI-Stateld as specified in 3GPP TS 38.331 [5], where i is the index of the codepoint of the DCI Transmission configuration indication field as specified in 3GPP TS 38.212 [9] and TCI state ID_{i,j} denotes the j^{th} TCI state indicated for the i^{th} codepoint in the DCI Transmission Configuration Indication field. The TCI codepoint to which the TCI States are mapped is determined by its ordinal position among all the TCI codepoints with sets of TCI state ID_{i,j} fields, i.e. the first TCI codepoint with TCI state ID_{0,1} and TCI state ID_{0,2} shall be mapped to the codepoint value 0, the second TCI codepoint with TCI state ID_{1,1} and TCI state ID_{1,2} shall be mapped to the codepoint value 1 and so on. The TCI state ID_{i,2} is optional based on the indication of the Cᵢ field. The maximum number of activated TCI codepoint is 8 and the maximum number of TCI states mapped to a TCI codepoint is 2; and
R: Reserved bit, set to “0”.

### Inter-Cell Multi-TRP Operation

In 3GPP NR Rel-17, inter-cell multi-TRP operation is to be specified. This is an extension of either single DCI-based multi-TRP or multiple DCI-based multi-TRP operation of 3GPP Rel-16. The intercell aspect of 3GPP Rel-17 refers to the case when the two TRPs are associated to different synchronization signal blocks (SSB) associated with different PCIs (Physical Cell IDs). That is, the TCI state that refers to transmission from TRP 1 or TRP 2 is quasi-collocated to a reference signal that is either one of the SSB beams with the PCI belonging to that TRP, or another reference signal like CSI-RS or DMRS that has root quasi-collocation assumption to one of the SSB beams with PCI belonging to that TRP.

### 3GPP Rel-17 TCI State Framework

In 3GPP Rel-17, a new unified TCI state framework is to be specified. Such framework considerations aim to streamline the indication of transmit/receive spatial filter (and other QCL properties) to the WD by letting a single TCI state indicate QCL properties for multiple different DL and/or UL signals/channels. To which DL and UL signals and/or channels that the unified TCI state framework should be applied to is still being considered by the 3GPP, as reflected in the following statements from 3GPP RAN1 #104-e:

### Statement

On 3GPP Rel.17 unified TCI framework, decide by RAN1 #104bis-e:
Whether DL or, if applicable, joint TCI also applies to the following signals. If not, any other enhancement over 3GPP Re1.15/16 is left for further study:
   CSI-RS resources for CSI;
   Some CSI-RS resources for beam management (BM), if so, which ones (e.g. aperiodic, repetition ‘ON’);
   CSI-RS for tracking;
Whether UL or, if applicable, joint TCI also applies to the following signals:
   Some SRS resources or resource sets for BM.

Note that the term ‘joint TCI’ in the above statement refers to a ‘joint DL/UL TCI state’.

RAN1 #103-e considered that the new unified TCI state framework could include a three stage TCI state indication (in a similar way as was described above for the PDSCH) for all or a subset of all DL and/or UL channels/signals. In the first stage, RRC is used to configure a pool of TCI states. In the second stage, one or more of the RRC configured TCI states are activated via MAC-CE signaling and associated to different TCI field codepoints in DCI format 1_1 and 1_2. Finally, in the third stage, DCI signaling is used to select one of the TCI states (or two TCI states in case separate TCI states are used for DL channels/signals and UL channels/signals) that was activated via MAC-CE.

In RAN1 #103-e, support for both joint beam indication (“Joint DL/UL TCI”) and separate DL/UL beam indication (“Separate DL/UL TCI”) was considered, as can be seen in the statements below. For Joint DL/UL TCI, a single TCI state (which can be a DL TCI state or a Joint DL/UL TCI state) is used to determine a transmit/receive spatial filter for both DL signals/channels and UL signals/channels. For Separate DL/UL TCI, one TCI state (for example, a DL TCI state) can be used to indicate a receive spatial filter for DL signals/channels and a separate TCI state (for example, an UL TCI state) can be used to indicate a transmit spatial filter for UL signals/channels.

### Statement

With respect to beam indication signaling medium to support joint or separate DL/UL beam indication in a 3GPP Rel-17 unified TCI framework:
Support L1-based beam indication using at least WD-specific (unicast) DCI to indicate joint or separate DL/UL beam indication from the active TCI states:
   The existing DCI formats 1_1 and 1_2 are reused for beam indication;
Support activation of one or more TCI states via MAC CE analogous to 3GPP Rel. 15/16.

### Statement

In the 3GPP Rel-17 unified TCI framework, to accommodate the case of separate beam indication for UL and DL:
Utilize two separate TCI states, one for DL and one for UL;
For the separate DL TCI:
   The source reference signal(s) in M TCIs provide QCL information at least for WD-dedicated reception on PDSCH and for WD-dedicated reception on all or subset of CORESETs in a CC;
For the separate UL TCI:
   The source reference signal(s) in N TCIs provide a reference for determining common UL TX spatial filter(s) at least for dynamic-grant/configured-grant based PUSCH, all or subset of dedicated PUCCH resources in a CC;
   Optionally, this UL TX spatial filter can also apply to all SRS resources in resource set(s) configured for antenna switching/codebook-based/non-codebook-based UL transmissions;
Whether the UL TCI state is taken from a common/same or separate TCI state pool from DL TCI state is left for further study.

### Ultra-Reliable Low Latency Communications (URLLC) Reliability for Multi-TRP Operation

In 3GPP NR Rel-16, multi-TRP reliability enhancements were specified for PDSCH by repeating PDSCH transmission (using time division multiplexing, frequency division multiplexing, and/or space division multiplexing) over two different TRPs. In 3GPP NR Rel-17, URLLC reliability enhancements will be extended also for PUSCH and PUCCH by using time division multiplexing (TDM) repetition from two different TRPs.

In 3GPP NR Rel-17, URLLC reliability enhancements are being extended for PUSCH and PUCCH by using TDM repetition from two different TRPs. In 3GPP NR Rel-17, it has been considered that PUSCH repetition to two TRPs in a cell will be supported. For that purpose, two sounding reference signal (SRS) resource sets with usage set to either ‘codebook’ or ‘nonCodebook’ will be introduced, each SRS resource set being associated with a TRP. PUSCH repetition to two TRPs can be scheduled by an UL related DCI with two SRS resource indicator (SRI) fields, where a first SRI is associated with a first SRS resource set and a second SRI is associated with a second SRS resource set.

An example is shown in FIG. 5, where a PUSCH repetition towards two TRPs is scheduled by a DCI indicating two SRIs. Both type A and type B PUSCH repetitions are supported.

Two types of mappings are supported between PUSCH transmission occasions to TRPs or UL beams, for example:
Cyclical mapping pattern: the first and second UL beams are applied to the first and second PUSCH repetitions, respectively, and the same beam mapping pattern continues to the remaining PUSCH repetitions; and
Sequential mapping pattern: the first beam is applied to the first and second PUSCH repetitions, and the second beam is applied to the third and fourth PUSCH repetitions, and the same beam mapping pattern continues to the remaining PUSCH repetitions.

The first and second UL beams are used to transmit PUSCH towards the first and second TRPs, respectively.

In 3GPP, considerations regarding UL transmission for frequency range FR2 have mainly been for a WD with single panel transmission (at each time instance). How to enable simultaneous transmission across multiple panels (ST×MP) remains unresolved.

In UL, a single codeword is used per PUSCH transmission. However, in case a PUSCH is transmitted to two different TRPs (using for example single DCI scheduling PUSCH transmission towards multiple TRPs), using the same codeword to both TRP might be sub-optimal, since the channel/interference situation might be different for the two TRPs. How to enable multiple codewords for PUSCH for ST×MP also remains unresolved.

### SUMMARY

Some embodiments may advantageously provide methods, network nodes, and wireless devices for providing a framework for simultaneous multi-panel uplink (UL) transmission.

Some embodiments may provide:
Signaling details for indication of ST×MP transmissions;
Signaling details for indicating a modulation and coding scheme (MCS) for two codewords of a PUSCH; and/or.

Details on how to handle PTRS for two MCS indications.

Some embodiments extend the new unified TCI framework to support ST×MP. With the solutions presented herein, the benefits of the new TCI framework (i.e., fast TCI state update) can be extended to simultaneous PUSCH transmissions.

According to one aspect, a network node configured to communicate with a wireless device, WD, includes: processing circuitry configured to configure the WD with at least two transmission configuration indicator, TCI, states. The network node further includes a radio interface in communication with the processing circuitry and configured to: transmit downlink control information, DCI, comprising an indication of a first TCI state and a second TCI state to be activated by the WD; and receive a first physical uplink shared channel, PUSCH, transmission occasion or a first set of PUSCH layers transmitted using a first spatial filter associated with the first TCI state, and receive a second PUSCH transmission occasion or a second set of PUSCH layers transmitted using a second spatial filter associated with the second TCI state.

According to this aspect, in some embodiments the indication is carried by a codepoint of a TCI field in the DCI. In some embodiments, the first and second TCI states are one of (a) a first and second Joint/DL TCI states, respectively, and (b) a first and a second UL TCI states, respectively. In some embodiments, the DCI further includes an indication of simultaneous transmission of at least one of the first PUSCH occasion, the first set of PUSCH layers and the second PUSCH occasion, and the second set of PUSCH layers. In some embodiments, the DCI further comprises an indication of a set of demodulation reference signal, DRMS, ports associated to the simultaneous transmission. In some embodiments, set of DMRS ports includes at least one of a first subset DMRS ports associated to at least one of the first PUSCH transmissions and the first set of PUSCH layers and a second subset of DMRS ports associated to at least one of the second PUSCH transmissions and the first and the second set of PUSCH layers. In some embodiments, the indication of the set of DMRS ports implicitly indicates at least one of a first number of layers associated to at least one of the first PUSCH transmissions and the first set of PUSCH layers, and a second number of layers associated to at least one of the second PUSCH transmissions and the first and the second set of PUSCH layers. In some embodiments, the simultaneous transmission is implicitly indicated when the first subset of DMRS ports are in a first code division multiplex, CDM, group and the second subset of DMRS ports are in a second CDM group, wherein the first and second CDM groups are different. In some embodiments, the simultaneous transmission is explicitly indicated by a codepoint of a bitfield in the DCI. In some embodiments, the simultaneous transmission is indicated by a Radio Resource Control, RRC, message. In some embodiments, the DCI further comprises first precoding information associated with at least one of the first PUSCH transmission occasion and transmission of the first set of PUSCH layers, and second precoding information associated with at least one of the second PUSCH transmission occasion and transmission of the second set of PUSCH layers. In some embodiments, the DCI further comprises a first sounding reference signal, SRS, resource indicator associated with at least one of the first PUSCH transmission occasion and transmission of the first set of PUSCH layers, and a second SRS resource indicator associated with at least one of the second PUSCH transmission occasion and transmission of the second set of PUSCH layers. In some embodiments, one of a first codeword and transmission layers associated with the first codeword are transmitted using a first of two indicated TCI states, and one of a second codeword and transmission layers associated with the second codeword are transmitted using a second of the two indicated TCI states. In some embodiments, at least one of a first modulation and coding scheme, MCS, field in scheduling uplink DCI, a first new data indicator field in the scheduling uplink DCI and a first redundancy version field in the scheduling uplink DCI is associated with a transmission corresponding to the first of the two indicated TCI states. In some embodiments, at least one of a second modulation and coding scheme, MCS, field in scheduling uplink DCI, a second new data indicator field in the scheduling uplink DCI and a second redundancy version field in the scheduling uplink DCI is associated with a transmission corresponding to the to the second of the two indicated TCI states. In some embodiments, the DCI further comprises information about a first DMRS port associated to a first phase tracking reference signal, PTRS, and information about a second DMRS port associated to a second PTRS, wherein the first DMRS port and the first PTRS are associated to the first PUSCH transmission and the second DMRS port and the second PTRS are associated to the first PUSCH transmission, and wherein the first and second DMRS ports are in the first and second code division multiplex, CDM, groups, respectively, and belong to the set of DMRS ports.

According to another aspect, a method in a network node configured to communicate with a wireless device, includes: configuring the WD (22) with at least two transmission configuration indicator, TCI, states; transmitting downlink control information, DCI, comprising an indication of a first TCI state and a second TCI state to be activated by the WD (22); and receiving a first physical uplink shared channel, PUSCH, transmission occasion or a first set of PUSCH layers transmitted using a first spatial filter associated with the first TCI state, and receive a second PUSCH transmission occasion or a second set of PUSCH layers transmitted using a second spatial filter associated with the second TCI state.

According to this aspect, in some embodiments, the indication is carried by a codepoint of a TCI field in the DCI. In some embodiments, the first and second TCI states are one of (a) a first and second Joint/DL TCI states, respectively, and (b) a first and a second UL TCI states, respectively. In some embodiments, the DCI further includes an indication of simultaneous transmission of at least one of the first PUSCH occasion, the first set of PUSCH layers and the second PUSCH occasion, and the second set of PUSCH layers. In some embodiments, the DCI further comprises an indication of a set of demodulation reference signal, DRMS, ports associated to the simultaneous transmission. In some embodiments, the set of DMRS ports includes at least one of a first subset DMRS ports associated to at least one of the first PUSCH transmissions and the first set of PUSCH layers and a second subset of DMRS ports associated to at least one of the second PUSCH transmissions and the first and the second set of PUSCH layers. In some embodiments, the indication of the set of DMRS ports implicitly indicates at least one of a first number of layers associated to at least one of the first PUSCH transmissions and the first set of PUSCH layers, and a second number of layers associated to at least one of the second PUSCH transmissions and the first and the second set of PUSCH layers. In some embodiments, the simultaneous transmission is implicitly indicated when the first subset of DMRS ports are in a first code division multiplex, CDM, group and the second subset of DMRS ports are in a second CDM group, wherein the first and second CDM groups are different. In some embodiments, the simultaneous transmission is explicitly indicated by a codepoint of a bitfield in the DCI. In some embodiments, the simultaneous transmission is indicated by a Radio Resource Control, RRC, message. In some embodiments, the DCI further comprises first precoding information associated with at least one of the first PUSCH transmission occasion and transmission of the first set of PUSCH layers, and second precoding information associated with at least one of the second PUSCH transmission occasion and transmission of the second set of PUSCH layers. In some embodiments, the DCI further comprises a first sounding reference signal, SRS, resource indicator associated with at least one of the first PUSCH transmission occasion and transmission of the first set of PUSCH layers, and a second SRS resource indicator associated with at least one of the second PUSCH transmission occasion and transmission of the second set of PUSCH layers. In some embodiments, one of a first codeword and transmission layers associated with the first codeword are transmitted using a first of two indicated TCI states, and one of a second codeword and transmission layers associated with the second codeword are transmitted using a second of the two indicated TCI states. In some embodiments, at least one of a first modulation and coding scheme, MCS, field in scheduling uplink DCI, a first new data indicator field in the scheduling uplink DCI and a first redundancy version field in the scheduling uplink DCI is associated with a transmission corresponding to the first of the two indicated TCI states. In some embodiments, at least one of a second modulation and coding scheme, MCS, field in scheduling uplink DCI, a second new data indicator field in the scheduling uplink DCI and a second redundancy version field in the scheduling uplink DCI is associated with a transmission corresponding to the to the second of the two indicated TCI states. In some embodiments, the DCI further comprises information about a first DMRS port associated to a first phase tracking reference signal, PTRS, and information about a second DMRS port associated to a second PTRS, wherein the first DMRS port and the first PTRS are associated to the first PUSCH transmission and the second DMRS port and the second PTRS are associated to the first PUSCH transmission, and wherein the first and second DMRS ports are in the first and second code division multiplex, CDM, groups, respectively, and belong to the set of DMRS ports.

According to yet another aspect, a WD configured to communicate with a network node, includes a radio interface configured to: receive from the network node a Downlink Control Information, DCI, comprising an indication that indicates a first and second TCI state; and transmit one of a first physical uplink shared channel, PUSCH, transmission occasion and a first set of PUSCH layers using a first spatial filter associated with the first TCI state, and transmit one of a second PUSCH transmission occasion and a second set of PUSCH layers using a second spatial filter associated with the second TCI state.

According to this aspect, in some embodiments, the indication is carried by a codepoint of a TCI field in the DCI. In some embodiments, the first and second TCI states are one of (a) a first and second Joint/DL TCI states, respectively, and (b) a first and a second UL TCI states, respectively. In some embodiments, the received DCI further includes an indication of simultaneous transmission of at least one of the first PUSCH occasion, the first set of PUSCH layers and the second PUSCH occasion, and the second set of PUSCH layers. In some embodiments, the received DCI further comprises an indication of a set of demodulation reference signal, DRMS, ports associated to the simultaneous transmission. In some embodiments, the set of DMRS ports includes at least one of a first subset DMRS ports associated to at least one of the first PUSCH transmissions and the first set of PUSCH layers and a second subset of DMRS ports associated to at least one of the second PUSCH transmissions and the first and the second set of PUSCH layers. In some embodiments, the indication of the set of DMRS ports implicitly indicates at least one of a first number of layers associated to at least one of the first PUSCH transmissions and the first set of PUSCH layers, and a second number of layers associated to at least one of the second PUSCH transmissions and the first and the second set of PUSCH layers. In some embodiments, the simultaneous transmission is implicitly indicated when the first subset of DMRS ports are in a first code division multiplex, CDM, group and the second subset of DMRS ports are in a second CDM group, wherein the first and second CDM groups are different. In some embodiments, the simultaneous transmission is explicitly indicated by a codepoint of a bitfield in the DCI. In some embodiments, the simultaneous transmission is indicated by a Radio Resource Control, RRC, message. In some embodiments, the DCI further comprises first precoding information associated with at least one of the first PUSCH transmission occasion and transmission of the first set of PUSCH layers, and second precoding information associated with at least one of the second PUSCH transmission occasion and transmission of the second set of PUSCH layers. In some embodiments, the DCI further comprises a first sounding reference signal, SRS, resource indicator associated with at least one of the first PUSCH transmission occasion and transmission of the first set of PUSCH layers, and a second SRS resource indicator associated with at least one of the second PUSCH transmission occasion and transmission of the second set of PUSCH layers. In some embodiments, one of a first codeword and transmission layers associated with the first codeword are transmitted using a first of two indicated TCI states, and one of a second codeword and transmission layers associated with the second codeword are transmitted using a second of the two indicated TCI states. In some embodiments, at least one of a first modulation and coding scheme, MCS, field in scheduling uplink DCI, a first new data indicator field in the scheduling uplink DCI and a first redundancy version field in the scheduling uplink DCI is associated with a transmission corresponding to the first of the two indicated TCI states. In some embodiments, at least one of a second modulation and coding scheme, MCS, field in scheduling uplink DCI, a second new data indicator field in the scheduling uplink DCI and a second redundancy version field in the scheduling uplink DCI is associated with a transmission corresponding to the to the second of the two indicated TCI states. In some embodiments, the DCI further comprises information about a first DMRS port associated to a first phase tracking reference signal, PTRS, and information about a second DMRS port associated to a second PTRS, wherein the first DMRS port and the first PTRS are associated to the first PUSCH transmission and the second DMRS port and the second PTRS are associated to the first PUSCH transmission, and wherein the first and second DMRS ports are in the first and second code division multiplex, CDM, groups, respectively, and belong to the set of DMRS ports.

According to another aspect, a method in a wireless device includes: receiving from the network node a Downlink Control Information, DCI, comprising an indication that indicates a first and second TCI state; and transmitting one of a first physical uplink shared channel, PUSCH, transmission occasion and a first set of PUSCH layers using a first spatial filter associated with the first TCI state, and transmit one of a second PUSCH transmission occasion and a second set of PUSCH layers using a second spatial filter associated with the second TCI state.

According to this aspect, in some embodiments, the indication is carried by a codepoint of a TCI field in the DCI. In some embodiments, the first and second TCI states are one of (a) a first and second Joint/DL TCI states, respectively, and (b) a first and a second UL TCI states, respectively. In some embodiments, the received DCI further includes an indication of simultaneous transmission of at least one of the first PUSCH occasion, the first set of PUSCH layers and the second PUSCH occasion, and the second set of PUSCH layers. In some embodiments, the received DCI further comprises an indication of a set of demodulation reference signal, DRMS, ports associated to the simultaneous transmission. In some embodiments, the set of DMRS ports includes at least one of a first subset DMRS ports associated to at least one of the first PUSCH transmissions and the first set of PUSCH layers and a second subset of DMRS ports associated to at least one of the second PUSCH transmissions and the first and the second set of PUSCH layers. In some embodiments, the indication of the set of DMRS ports implicitly indicates at least one of a first number of layers associated to at least one of the first PUSCH transmissions and the first set of PUSCH layers, and a second number of layers associated to at least one of the second PUSCH transmissions and the first and the second set of PUSCH layers. In some embodiments, the simultaneous transmission is implicitly indicated when the first subset of DMRS ports are in a first code division multiplex, CDM, group and the second subset of DMRS ports are in a second CDM group, wherein the first and second CDM groups are different. In some embodiments, the simultaneous transmission is explicitly indicated by a codepoint of a bitfield in the DCI. In some embodiments, the simultaneous transmission is indicated by a Radio Resource Control, RRC, message. In some embodiments, the DCI further comprises first precoding information associated with at least one of the first PUSCH transmission occasion and transmission of the first set of PUSCH layers, and second precoding information associated with at least one of the second PUSCH transmission occasion and transmission of the second set of PUSCH layers. In some embodiments, the DCI further comprises a first sounding reference signal, SRS, resource indicator associated with at least one of the first PUSCH transmission occasion and transmission of the first set of PUSCH layers, and a second SRS resource indicator associated with at least one of the second PUSCH transmission occasion and transmission of the second set of PUSCH layers. In some embodiments, one of a first codeword and transmission layers associated with the first codeword are transmitted using a first of two indicated TCI states, and one of a second codeword and transmission layers associated with the second codeword are transmitted using a second of the two indicated TCI states. In some embodiments, at least one of a first modulation and coding scheme, MCS, field in scheduling uplink DCI, a first new data indicator field in the scheduling uplink DCI and a first redundancy version field in the scheduling uplink DCI is associated with a transmission corresponding to the first of the two indicated TCI states. In some embodiments, at least one of a second modulation and coding scheme, MCS, field in scheduling uplink DCI, a second new data indicator field in the scheduling uplink DCI and a second redundancy version field in the scheduling uplink DCI is associated with a transmission corresponding to the to the second of the two indicated TCI states. In some embodiments, the DCI further comprises information about a first DMRS port associated to a first phase tracking reference signal, PTRS, and information about a second DMRS port associated to a second PTRS, wherein the first DMRS port and the first PTRS are associated to the first PUSCH transmission and the second DMRS port and the second PTRS are associated to the first PUSCH transmission, and wherein the first and second DMRS ports are in the first and second code division multiplex, CDM, groups, respectively, and belong to the set of DMRS ports.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates a two step TCI state update process;

FIG. 2 illustrates TCI states activation/deactivation;

FIG. 3 illustrates an example of DCI TCI state indication;

FIG. 4 illustrates enhanced TCI states activation/deactivation;

FIG. 5 illustrates an example of PUSCH repetitions to two TRPs;

FIG. 6 is a schematic diagram of an example network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating example methods implemented in a communication system including a host computer, a network node and a wireless device for executing a client application at a wireless device according to some embodiments of the present disclosure;

FIG. 9 is a flowchart illustrating example methods implemented in a communication system including a host computer, a network node and a wireless device for receiving user data at a wireless device according to some embodiments of the present disclosure;

FIG. 10 is a flowchart illustrating example methods implemented in a communication system including a host computer, a network node and a wireless device for receiving user data from the wireless device at a host computer according to some embodiments of the present disclosure;

FIG. 11 is a flowchart illustrating example methods implemented in a communication system including a host computer, a network node and a wireless device for receiving user data at a host computer according to some embodiments of the present disclosure;

FIG. 12 is a flowchart of an example process in a network node providing a framework for simultaneous multi-panel uplink (UL) transmission;

FIG. 13 is a flowchart of an example process in a wireless device for providing a framework for simultaneous multi-panel uplink (UL) transmission;

FIG. 14 is a flowchart of an example process in a network node providing a framework for simultaneous multi-panel uplink (UL) transmission;

FIG. 15 is a flowchart of an example process in a wireless device for providing a framework for simultaneous multi-panel uplink (UL) transmission;

FIG. 16 is a first example of TCI states;

FIG. 17 is a second example of TCI states;

FIG. 18 is a third example of TCI states;

FIG. 19 is fourth example of TCI states;

FIG. 20 is a fifth example of TCI states;

FIG. 21 is an example of a bitfield for UL DCI formats; and

FIG. 22 is an example of a PUSCH-Config information element (IE).

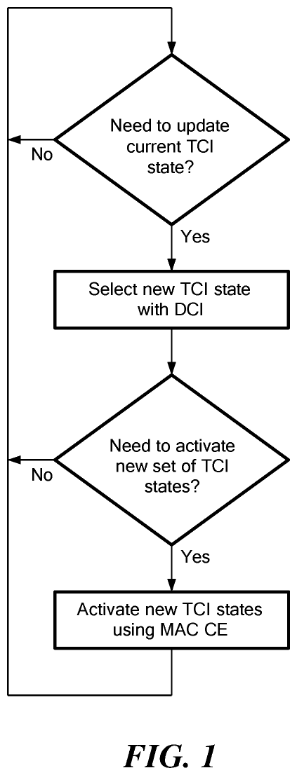

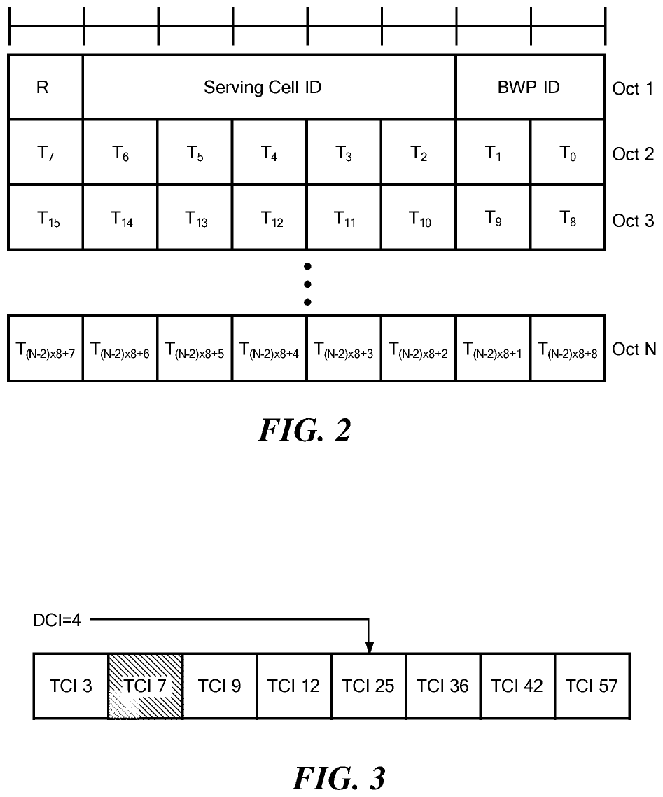

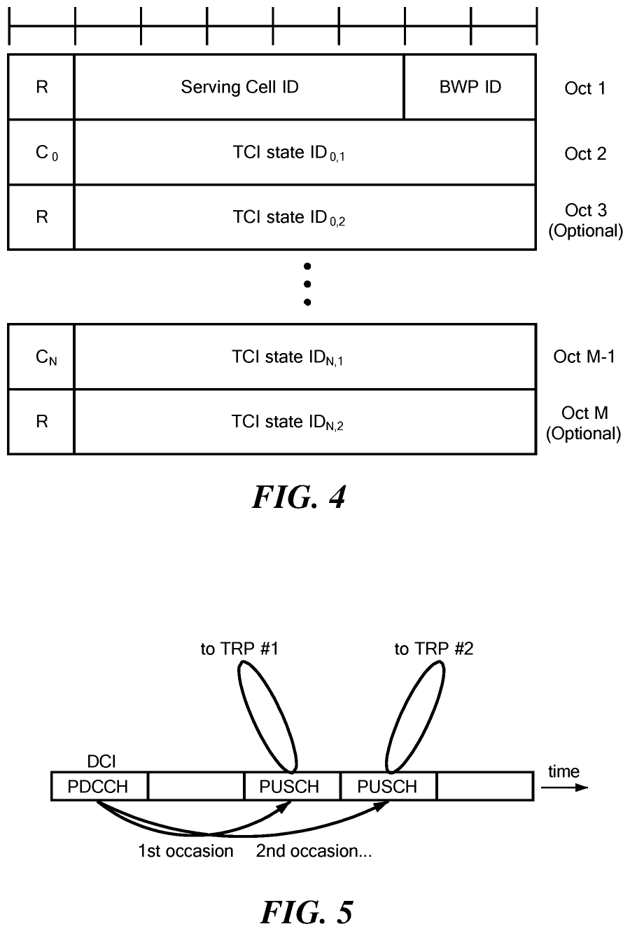

### DETAILED DESCRIPTION

Before describing in detail example embodiments, it is noted that the embodiments reside primarily in combinations of apparatus components and processing steps related to a framework for simultaneous multi-panel uplink (UL) transmission. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide a framework for simultaneous multi-panel uplink (UL) transmission.

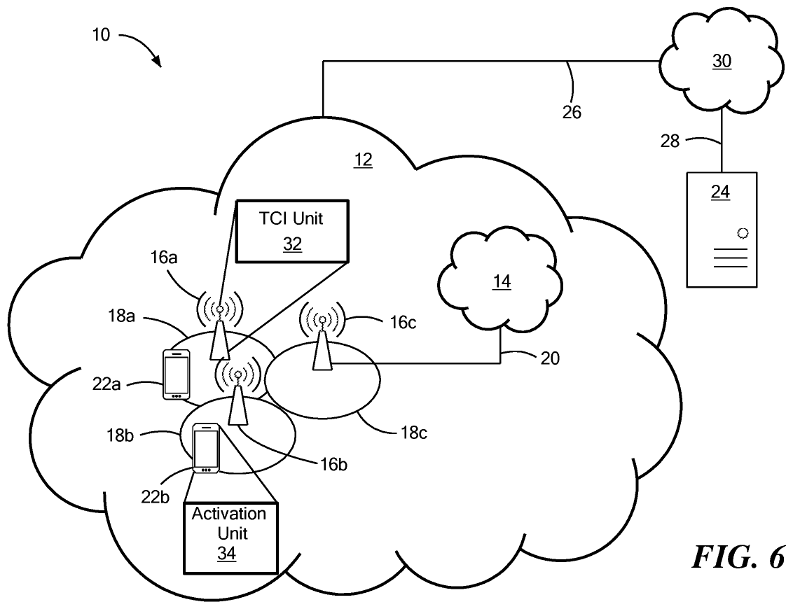

Referring again to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a. 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a TCI unit 32 which is configured to configure the WD 22 with at least two transmission configuration indicator, TCI, states. The TCI unit 32 may also be configured to transmit an indication of at least one of the at least two configured TCI states to be activated by the WD. The indication may indicate to the WD a pair of activated uplink, UL, transmission configuration indicator. TCI, states for one of a plurality of multi-transmission reception point, multi-TRP, physical uplink shared channel, PUSCH, transmission schemes. A wireless device 22 is configured to include an activation unit 34 configured to activate an indicated at least one TCI state. The activation unit 34 may also be configured to determine one of a plurality of multi-transmission reception point, multi-TRP, physical uplink shared channel, PUSCH, transmission schemes based on a pair of activated uplink, UL, transmission configuration indicator, TCI, states indicated by the network node.

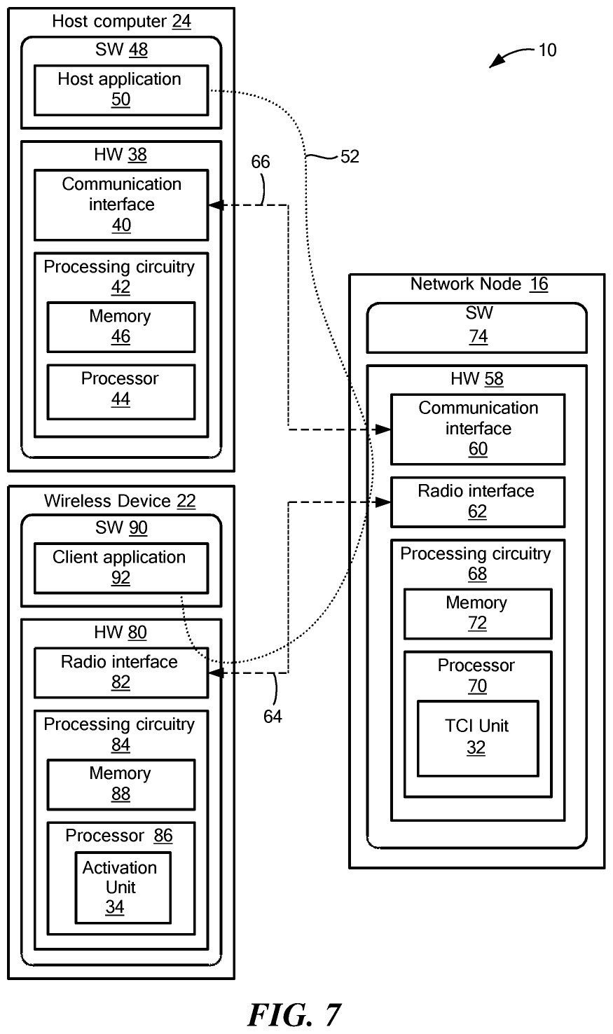

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a TCI unit 32 which is configured to configure the WD 22 with at least two transmission configuration indicator, TCI, states. The TCI unit 32 may also be configured to transmit an indication of at least one of the at least two configured TCI states to be activated by the WD. The indication may indicate to the WD a pair of activated uplink, UL, transmission configuration indicator, TCI, states for one of a plurality of multi-transmission reception point, multi-TRP, physical uplink shared channel, PUSCH, transmission schemes.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers. The radio interface 82 is configured to receive from the network node a Downlink Control Information, DCI, comprising an indication that indicates a first and second TCI state. The radio interface 82 is also configured to transmit one of a first physical uplink shared channel, PUSCH, transmission occasion and a first set of PUSCH layers using a first spatial filter associated with the first TCI state, and transmit one of a second PUSCH transmission occasion and a second set of PUSCH layers using a second spatial filter associated with the second TCI state.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an activation unit 34 configured to activate an indicated at least one TCI state. The activation unit 34 may also be configured to determine one of a plurality of multi-transmission reception point, multi-TRP, physical uplink shared channel, PUSCH, transmission schemes based on a pair of activated uplink, UL, transmission configuration indicator, TCI, states indicated by the network node.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as TCI unit 32, and activation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

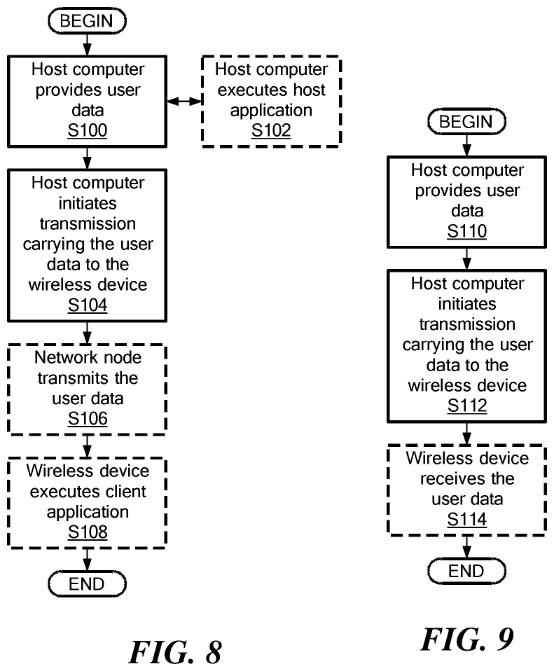

FIG. 8 is a flowchart illustrating an example method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

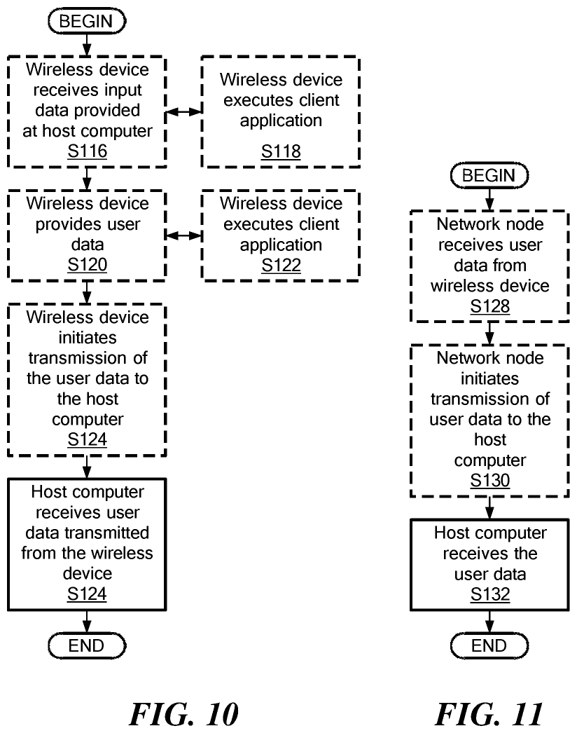

FIG. 10 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

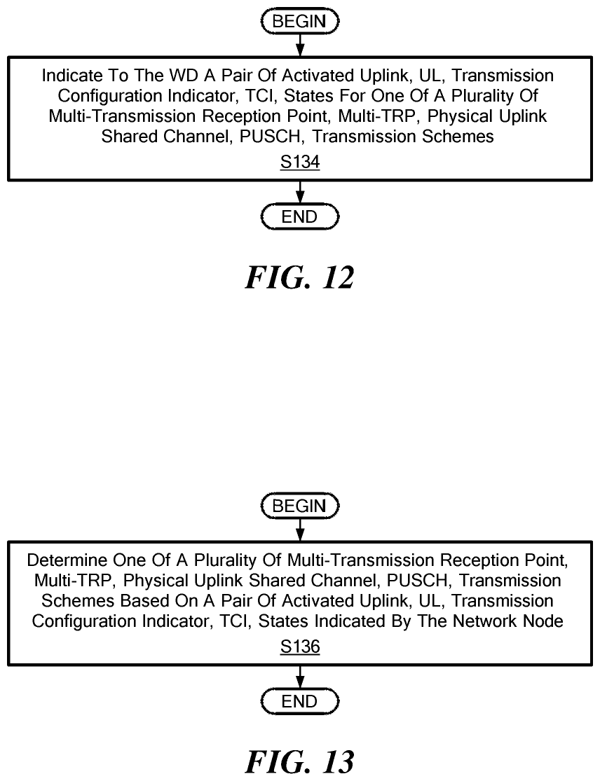

FIG. 12 is a flowchart of an example process in a network node 16 for providing a framework for simultaneous multi-panel uplink (UL) transmission. One or more blocks described herein may be performed by one or more elements of network node 16 such as by one or more of processing circuitry 68 (including the TCI unit 32), processor 70, radio interface 62 and/or communication interface 60. Network node 16 such as via processing circuitry 68 and/or processor 70 and/or radio interface 62 and/or communication interface 60 is configured to indicate to the WD a pair of activated uplink, UL, transmission configuration indicator, TCI, states for one of a plurality of multi-transmission reception point, multi-TRP, physical uplink shared channel, PUSCH, transmission schemes (Block S134).

FIG. 13 is a flowchart of an example process in a wireless device 22 according to some embodiments of the present disclosure. One or more blocks described herein may be performed by one or more elements of wireless device 22 such as by one or more of processing circuitry 84 (including the activation unit 34), processor 86, radio interface 82 and/or communication interface 60. Wireless device 22 such as via processing circuitry 84 and/or processor 86 and/or radio interface 82 is configured to determine one of a plurality of multi-transmission reception point, multi-TRP, physical uplink shared channel, PUSCH, transmission schemes based on a pair of activated uplink, UL, transmission configuration indicator, TCI, states indicated by the network node (Block S136).

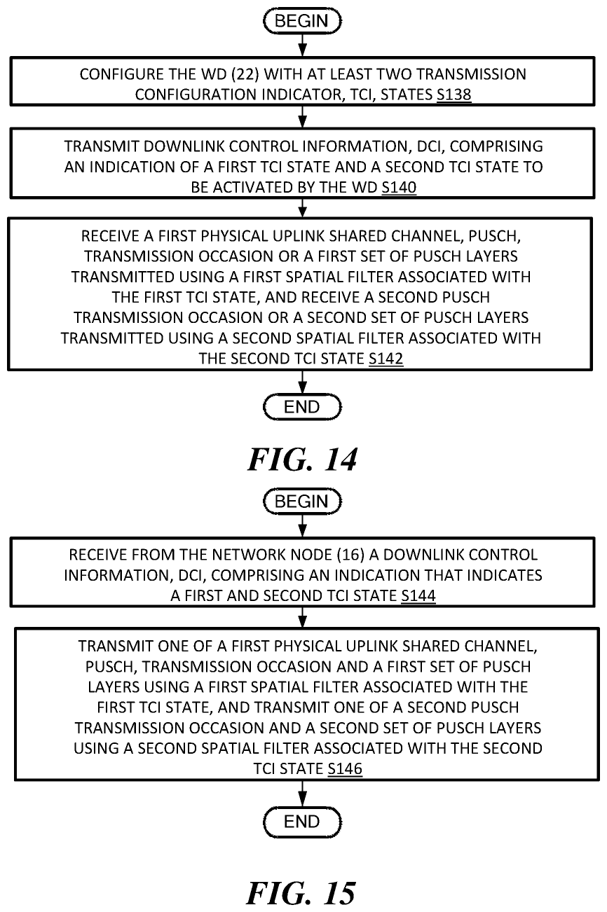

FIG. 14 is a flowchart of an example process in a network node 16 for providing a framework for simultaneous multi-panel uplink (UL) transmission. One or more blocks described herein may be performed by one or more elements of network node 16 such as by one or more of processing circuitry 68 (including the TCI unit 32), processor 70, radio interface 62 and/or communication interface 60. Network node 16 such as via processing circuitry 68 and/or processor 70 and/or radio interface 62 and/or communication interface 60 is configured to configure the WD with at least two transmission configuration indicator, TCI, states (Block S138). The process also includes transmitting transmit downlink control information, DCI, comprising an indication of a first TCI state and a second TCI state to be activated by the WD (Block S140). The process also includes receiving a first physical uplink shared channel, PUSCH, transmission occasion or a first set of PUSCH layers transmitted using a first spatial filter associated with the first TCI state, and receive a second PUSCH transmission occasion or a second set of PUSCH layers transmitted using a second spatial filter associated with the second TCI state (Block S142).

In some embodiments the indication is carried by a codepoint of a TCI field in the DCI. In some embodiments, the first and second TCI states are one of (a) a first and second Joint/DL TCI states, respectively, and (b) a first and a second UL TCI states, respectively. In some embodiments, the DCI further includes an indication of simultaneous transmission of at least one of the first PUSCH occasion, the first set of PUSCH layers and the second PUSCH occasion, and the second set of PUSCH layers. In some embodiments, the DCI further comprises an indication of a set of demodulation reference signal, DRMS, ports associated to the simultaneous transmission. In some embodiments, set of DMRS ports includes at least one of a first subset DMRS ports associated to at least one of the first PUSCH transmissions and the first set of PUSCH layers and a second subset of DMRS ports associated to at least one of the second PUSCH transmissions and the first and the second set of PUSCH layers. In some embodiments, the indication of the set of DMRS ports implicitly indicates at least one of a first number of layers associated to at least one of the first PUSCH transmissions and the first set of PUSCH layers, and a second number of layers associated to at least one of the second PUSCH transmissions and the first and the second set of PUSCH layers. In some embodiments, the simultaneous transmission is implicitly indicated when the first subset of DMRS ports are in a first code division multiplex, CDM, group and the second subset of DMRS ports are in a second CDM group, wherein the first and second CDM groups are different. In some embodiments, the simultaneous transmission is explicitly indicated by a codepoint of a bitfield in the DCI. In some embodiments, the simultaneous transmission is indicated by a Radio Resource Control, RRC, message. In some embodiments, the DCI further comprises first precoding information associated with at least one of the first PUSCH transmission occasion and transmission of the first set of PUSCH layers, and second precoding information associated with at least one of the second PUSCH transmission occasion and transmission of the second set of PUSCH layers. In some embodiments, the DCI further comprises a first sounding reference signal, SRS, resource indicator associated with at least one of the first PUSCH transmission occasion and transmission of the first set of PUSCH layers, and a second SRS resource indicator associated with at least one of the second PUSCH transmission occasion and transmission of the second set of PUSCH layers. In some embodiments, one of a first codeword and transmission layers associated with the first codeword are transmitted using a first of two indicated TCI states, and one of a second codeword and transmission layers associated with the second codeword are transmitted using a second of the two indicated TCI states. In some embodiments, at least one of a first modulation and coding scheme, MCS, field in scheduling uplink DCI, a first new data indicator field in the scheduling uplink DCI and a first redundancy version field in the scheduling uplink DCI is associated with a transmission corresponding to the first of the two indicated TCI states. In some embodiments, at least one of a second modulation and coding scheme, MCS, field in scheduling uplink DCI, a second new data indicator field in the scheduling uplink DCI and a second redundancy version field in the scheduling uplink DCI is associated with a transmission corresponding to the to the second of the two indicated TCI states. In some embodiments, the DCI further comprises information about a first DMRS port associated to a first phase tracking reference signal, PTRS, and information about a second DMRS port associated to a second PTRS, wherein the first DMRS port and the first PTRS are associated to the first PUSCH transmission and the second DMRS port and the second PTRS are associated to the first PUSCH transmission, and wherein the first and second DMRS ports are in the first and second code division multiplex, CDM, groups, respectively, and belong to the set of DMRS ports.

FIG. 15 is a flowchart of an example process in a wireless device 22 according to some embodiments of the present disclosure. One or more blocks described herein may be performed by one or more elements of wireless device 22 such as by one or more of processing circuitry 84 (including the activation unit 34), processor 86, radio interface 82 and/or communication interface 60. Wireless device 22 such as via processing circuitry 84 and/or processor 86 and/or radio interface 82 is configured to receive from the network node (16) a Downlink Control Information, DCI, comprising an indication that indicates a first and second TCI state (Block S144). The process also includes transmitting one of a first physical uplink shared channel, PUSCH, transmission occasion and a first set of PUSCH layers using a first spatial filter associated with the first TCI state, and transmit one of a second PUSCH transmission occasion and a second set of PUSCH layers using a second spatial filter associated with the second TCI state (Block S146).

In some embodiments, the indication is carried by a codepoint of a TCI field in the DCI. In some embodiments, the first and second TCI states are one of (a) a first and second Joint/DL TCI states, respectively, and (b) a first and a second UL TCI states, respectively. In some embodiments, the received DCI further includes an indication of simultaneous transmission of at least one of the first PUSCH occasion, the first set of PUSCH layers and the second PUSCH occasion, and the second set of PUSCH layers. In some embodiments, the received DCI further comprises an indication of a set of demodulation reference signal, DRMS, ports associated to the simultaneous transmission. In some embodiments, the set of DMRS ports includes at least one of a first subset DMRS ports associated to at least one of the first PUSCH transmissions and the first set of PUSCH layers and a second subset of DMRS ports associated to at least one of the second PUSCH transmissions and the first and the second set of PUSCH layers. In some embodiments, the indication of the set of DMRS ports implicitly indicates at least one of a first number of layers associated to at least one of the first PUSCH transmissions and the first set of PUSCH layers, and a second number of layers associated to at least one of the second PUSCH transmissions and the first and the second set of PUSCH layers. In some embodiments, the simultaneous transmission is implicitly indicated when the first subset of DMRS ports are in a first code division multiplex, CDM, group and the second subset of DMRS ports are in a second CDM group, wherein the first and second CDM groups are different. In some embodiments, the simultaneous transmission is explicitly indicated by a codepoint of a bitfield in the DCI. In some embodiments, the simultaneous transmission is indicated by a Radio Resource Control, RRC, message. In some embodiments, the DCI further comprises first precoding information associated with at least one of the first PUSCH transmission occasion and transmission of the first set of PUSCH layers, and second precoding information associated with at least one of the second PUSCH transmission occasion and transmission of the second set of PUSCH layers. In some embodiments, the DCI further comprises a first sounding reference signal, SRS, resource indicator associated with at least one of the first PUSCH transmission occasion and transmission of the first set of PUSCH layers, and a second SRS resource indicator associated with at least one of the second PUSCH transmission occasion and transmission of the second set of PUSCH layers. In some embodiments, one of a first codeword and transmission layers associated with the first codeword are transmitted using a first of two indicated TCI states, and one of a second codeword and transmission layers associated with the second codeword are transmitted using a second of the two indicated TCI states. In some embodiments, at least one of a first modulation and coding scheme, MCS, field in scheduling uplink DCI, a first new data indicator field in the scheduling uplink DCI and a first redundancy version field in the scheduling uplink DCI is associated with a transmission corresponding to the first of the two indicated TCI states. In some embodiments, at least one of a second modulation and coding scheme, MCS, field in scheduling uplink DCI, a second new data indicator field in the scheduling uplink DCI and a second redundancy version field in the scheduling uplink DCI is associated with a transmission corresponding to the to the second of the two indicated TCI states. In some embodiments, the DCI further comprises information about a first DMRS port associated to a first phase tracking reference signal, PTRS, and information about a second DMRS port associated to a second PTRS, wherein the first DMRS port and the first PTRS are associated to the first PUSCH transmission and the second DMRS port and the second PTRS are associated to the first PUSCH transmission, and wherein the first and second DMRS ports are in the first and second code division multiplex, CDM, groups, respectively, and belong to the set of DMRS ports.

Having described the general process flow of arrangements of the disclosure and having provided examples of hardware and software arrangements for implementing the processes and functions of the disclosure, the sections below provide details and examples of arrangements for providing a framework for simultaneous multi-panel uplink (UL) transmission.

As used herein, a TCI state may refer to a “DL TCI state,” an “UL TCI state”, and/or a “Joint DL/UL TCI state”.

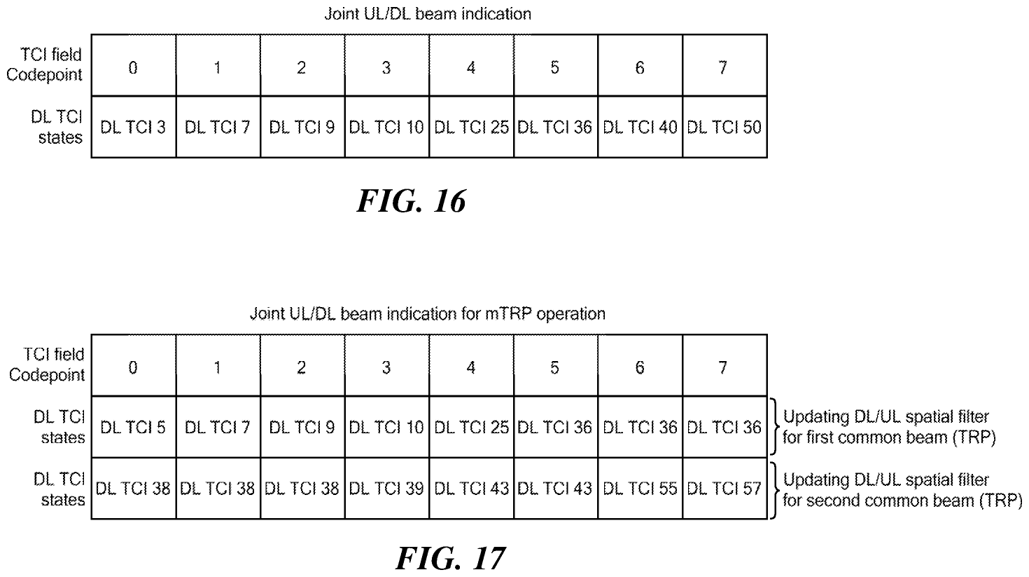

FIG. 16 illustrates a schematic example where a list of activated DL TCI states are mapped to a set of TCI field codepoints in a DCI for Joint DL/UL TCI update for single-TRP based operation. The mapping of DL TCI states to codepoints in the TCI field may be done by MAC CE. In this case, a codepoint of the TCI field in DCI is used to update a DL TCI state, which will be used by the WD 22 to determine TX/RX spatial filter for both DL and UL signals/channels. For example, in case codepoint 2 is indicated to the WD 22, the WD 22 may update its TX/RX spatial filters based on DL TCI state 9 for both DL and UL signals/channels.

FIG. 17 illustrates a schematic example where a list of activated DL TCI state pairs are mapped to a set of TCI field codepoints in a DCI for Joint DL/UL TCI update for multi-TRP based operation. In this case, a single TCI field codepoint in DCI is used to update two DL TCI states, which may be used to determine two TX/RX spatial filters for both DL and UL signals/channels (e.g. one spatial filter per TRP). For example, in case a DCI with TCI field codepoint 2 is indicated to the WD 22, the WD 22 may update one TX/RX spatial filter based on DL TCI state 9 for both DL and UL signals/channels associated to a first TRP, and one TX/RX spatial filter based on DL TCI state 38 for both DL and UL signals/channels associated to a second TRP.

In some embodiments, some TCI field codepoints are associated with two DL TCI states (or joint DL/UL TCI states), and some TCI field codepoints are associated with a single DL TCI state (or joint DL/UL TCI state). In this case, it may be assumed that an indication of a TCI state codepoint associated with a single DL TCI state (or joint DL/UL TCI state), indicates to the WD 22 to update the TX/RX spatial filter for only one of the TRPs (while maintaining the current TX/RX spatial filter for the other TRP).

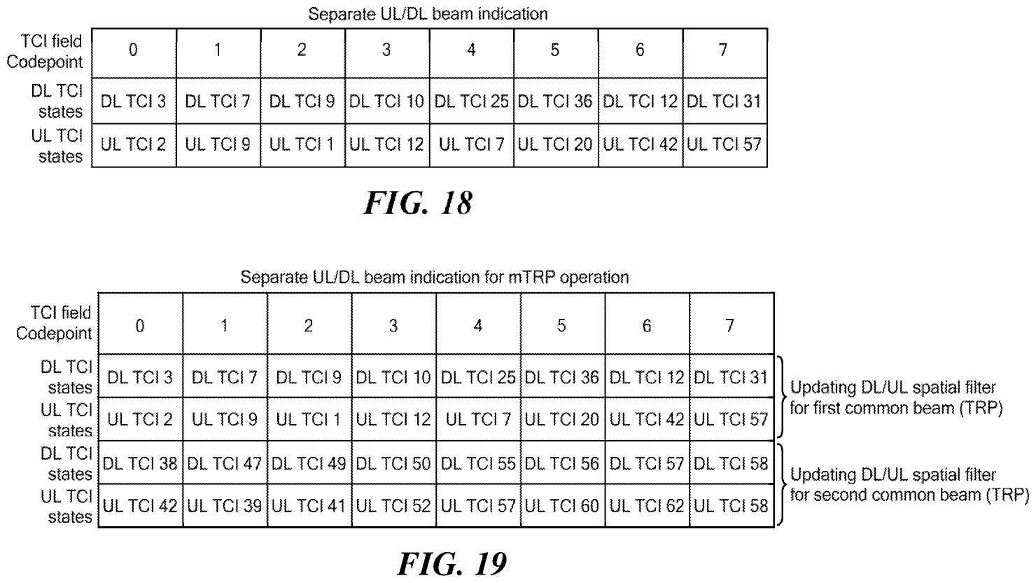

FIG. 18 illustrates a schematic example of how a list of activated DL/UL TCI states and their association to TCI field codepoints in DCI might look for separate DL/UL TCI for single-TRP operation. Here, each TCI field codepoint in DCI is associated with one DL TCI state and one UL TCI state. When a WD 22 is indicated with a certain TCI field codepoint which is mapped to one DL TCI state and one UL TCI state, the WD 22 may apply one DL TCI state and one UL TCI state. That is, the WD 22 may update the RX spatial filter based on the indicated DL TCI state and update the TX spatial filter based on the indicated UL TCI state.

FIG. 19 illustrates a schematic example of how a list of activated DL/UL TCI states and their association to TCI field codepoints in DCI might look for separate DL/UL TCI for multi-TRP operation. Here, each TCI field codepoint in DCI is associated with two DL TCI states and two UL TCI states. In this case, a single TCI field codepoint in DCI is used to update two DL TCI states and two UL TCI states, which may be used to determine two RX spatial filter for DL signals/channels (e.g., one spatial filter per TRP) and two TX spatial filter for UL signals/channels. For example, in case a DCI with TCI field codepoint 2 is indicated to the WD 22, the WD 22 may update one RX spatial filter based on DL TCI state 9 for DL signals/channels from a first TRP, one RX spatial filter based on DL TCI state 49 for DL signals/channels from a second TRP, one TX spatial filter based on UL TCI state 1 for UL signals/channels from a first TRP and one TX spatial filter based on UL TCI state 41 for UL signals/channels from a second TRP.

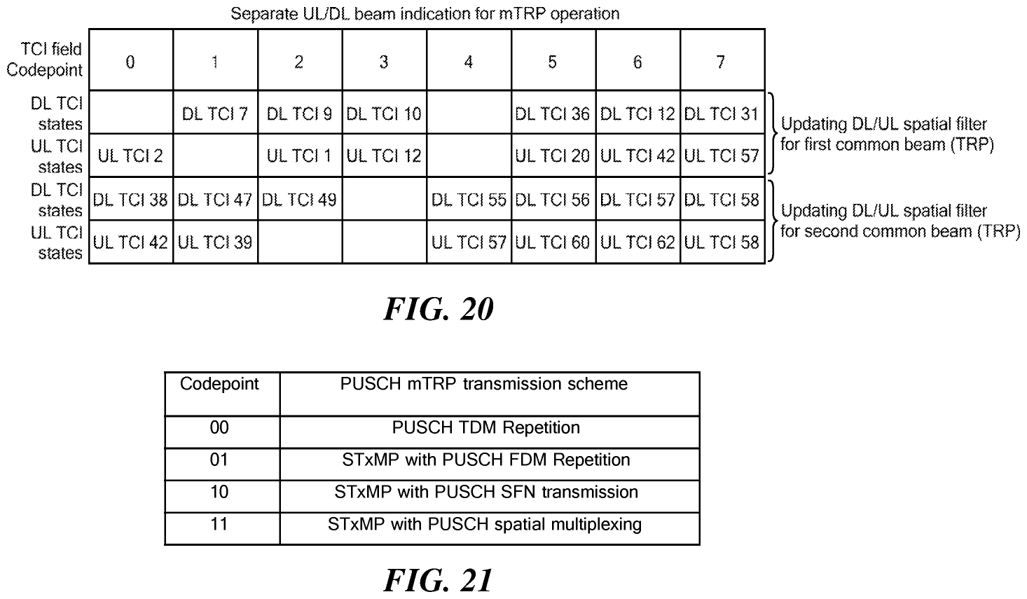

In some embodiments, some TCI field codepoints are associated with zero, one or two DL TCI states and/or zero, one or two UL TCI states. An example of this is shown in FIG. 20. In this case, it may be assumed that an indication of a TCI state codepoint that is associated with a single DL state and/or single UL TCI state, indicates to the WD 22 to update the TX and/or RX spatial filter for only one of the TRPs (while maintaining the current TX and/or RX spatial filter for the other TRP). If zero DL TCI states are associated with an indicated TCI field codepoint, the WD 22 may not update its RX spatial filter(s) (i.e., the WD 22 may only update the TX spatial filer(s) based on the associated UL TCI state(s)). In a similar way, if zero UL TCI states are associated with an indicted TCI field codepoint, the WD 22 may not update its TX spatial filter(s) (i.e., the WD 22 may only update the RX spatial filters based on the associated DL TCI state(s)).

In some embodiments, a TRP may be either a network node 16, a radio head, a spatial relation, or a Transmission Configuration Indicator (TCI) state. A TRP may be represented by a TCI state in some embodiments. In some embodiments, a TRP may be using multiple TCI states. In some embodiments, a TRP may be a part of the network node 16 (e.g., gNB) transmitting and receiving radio signals to/from a WD 22 according to physical layer properties and parameters inherent to that element. In some embodiments, a TRP may be a part of the network node 16 transmitting and receiving radio signals to/from the WD 22 according to physical layer properties and parameters inherent to that element. In some embodiments, in Multiple Transmit/Receive Point (multi-TRP) operation, a serving cell may schedule WD 22 from two TRPs, providing better PDSCH coverage, reliability and/or data rates. There are two different operation modes for multi-TRP: single-DCI and multi-DCI. For both modes, control of uplink and downlink operation is done by both physical layer and MAC. In single-DCI mode, the WD 22 may be scheduled by the same DCI for both TRPs and in multi-DCI mode, the WD 22 may be scheduled by independent DCIs from each TRP. In some embodiments, a TRP may be represented by a SRS resource set, a SRI field in UL related DCI, or a TPMI field in UL related DCI.

Some embodiments may provide one or more of the following:
Signaling details for indication of ST×MP transmissions;
Signaling details for indicating MCS for two codewords of an PUSCH; and/or
Details on how to handle PTRS for two MCS indications.

### Embodiment 1: Indication of ST×MP Transmissions

In some embodiments, a ST×MP transmission for the PUSCH is triggered implicitly when two UL TCI states are applied (i.e., two TX spatial filters are applied for UL). However, other multi-TRP reliability schemes (e.g., TDM PUSCH repetition) may be specified for the unified TCI state framework, which may require two activated UL TCI states. In such case, there may be differentiation between WDs as to which scheme (ST×MP. TDM repetition or potential other multi-TRP feature) the WD 22 should apply for the triggered PUSCH. In other words, when two activated UL TCI states are indicated, the WD 22 may differentiate between two activated UL TCI states for ST×MP or TDM based repetition (or any other multi-TRP PUSCH transmission scheme).

In some embodiments, the WD 22 determines which multi-TRP PUSCH transmission scheme to use based on RRC configuration and/or DCI indication. Below are some detailed descriptions of some embodiments.

In some embodiments, only RRC configuration is used. For example, there may be a new RRC parameter configured in e.g. “PUSCH-TimeDomainResourceAllocationList” or “PUSCH-TimeDomainResourceAllocationListNew” (or a similar new Information Element) as defined in 3GPP TS 38.331, which indicates to the WD 22 if TDM based repetition or ST×MP transmission (or another candidate multi-TRP transmission scheme) should be applied for the transmission associated with triggered/scheduled PUSCH.

In some embodiments, in addition to potential RRC configuration in “PUSCH-TimeDomainResourceAllocationList” or “PUSCH-TimeDomainResourceAllocationListNew” (or a similar new Information Element), the “antennaPort-bitfield” or antenna port bit field in an UL DCI format as specified in 3GPP TS 38.212 may be used to implicitly indicate to the WD 22 whether, for example, PUSCH TDM repetition should applied or ST×MP PUSCH transmission should be applied. For example, when there are two UL TCI states applied for the unified TCI state framework and the antenna Port bit field codepoint indicates DMRS ports in a single CDM group for the PUSCH DMRS (as specified for example in Table 7.3.1.2.2-12 in 3GPP TS 38.212), the WD 22 may assume that PUSCH TDM repetition should be applied, while if the antenna Port bit field codepoint indicates DMRS ports in two CDM groups for the PUSCH DMRS, the WD 22 may assume that ST×MP PUSCH transmission should be applied.

In some embodiments, an explicit indication in a dedicated bitfield (or at least one codepoint in a dedicated bitfield) in UL DCI formats are used to indicate a multi-TRP PUSCH transmission scheme for the triggered PUSCH. In one example illustrated in FIG. 21, a two-bit bitfield is used with the following codepoint interpretations. Note that this is just one example, and fewer or more candidate PUSCH multi-TRP transmission schemes may be indicated with the dedicated bitfield, and the dedicated bitfield may have a different length other than 2 bits and a different number of codepoints other than 4 codepoints in the general case. In this example, three out of four codepoints correspond to different types of ST×MP transmission. Codepoint ‘01’, corresponds to ST×MP transmission where the two WD panels transmit the same data to two different TRPs, and where the data is located at different parts of the frequency band (e.g., different set of resource blocks in the frequency domain within the system bandwidth or active bandwidth). Codepoint ‘10’, corresponds to ST×MP transmission where the two WD panels transmit the same data to two different TRPs, and where the data is overlapping in time and frequency. Codepoint ‘11’, corresponds to ST×MP transmission where the two WD panels transmit different data (for example different transport blocks or different layers of the same transport block) to two different TRPs using the same frequency and time allocations.

A panel may correspond to one of the UL TCI states applied by the WD 22 for PUSCH transmission or the UL TX spatial filter corresponding to the one of the UL TCI states applied by the WD 22 for PUSCH transmission. In an alternative embodiment, a panel at the WD 22 may be identified with an explicit panel identifier.

In some embodiments, a new bitfield is included in the UL DCI formats when a new parameter is RRC configured (e.g. “support ST×MP”) in for example PUSCH-Config 1E as specified in 3GPP TS 38.331. The new parameter may be configured for WDs based on WD 22 capability, such that only WDs that report supporting ST×MP may be configured with this parameter. Note that this parameter may be configured in other places, for example PUSCH-ConfigCommon IE as specified in 3GPP TS 38.331.

### Embodiment 2: Signaling Details for Indicating MCS for Two Codewords of a PUSCH

In current NR specifications, UL only supports a single codeword for PUSCH. However, in case ST×MP with spatial multiplexing to two different TRPs may be performed, for example, using the same MCS for the PUSCH transmitted to both TRPs may in some cases be sub-optimal (due to for example different channel/interference situations for respective TRP). One way to mitigate this problem is to use two codewords for PUSCH ST×MP transmission, each with an individual MCSs (one MCS associated with each codeword). In current NR UL DCI formats, a single MCS bitfield is used for indicating a single MCS for a single codeword.

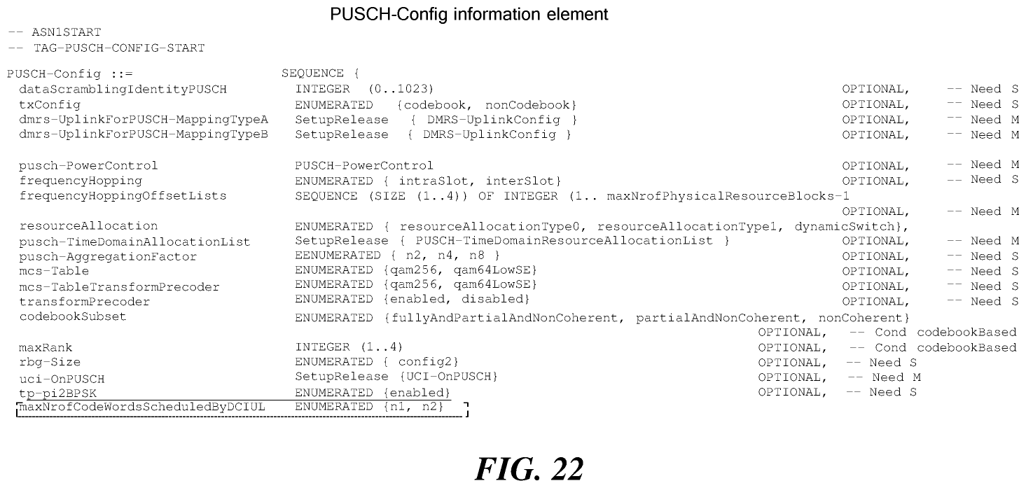

In some embodiments, a second MCS bitfield together with a second new data indicator (NDI) field and a second redundancy version (RV) field are included in UL DCI formats when a new RRC parameter (for example a parameter called “maxNrofCodeWordsScheduledByDCIUL”) is configured and set to 2. The information element IE shown in FIG. 22 illustrates one example where this parameter is configured in PUSCH-Config IE as specified in 3GPP TS 38.331. When two codewords are configured for the WD 22 (e.g., by setting “maxNrofCodeWordsScheduledByDCIUL” to 2), one codeword (or a first set of PUSCH transmission layers corresponding to a first codeword) are transmitted via ST×MP using the UL TX spatial filter associated with a first activated/indicated UL TCI state (or joint UL/DL TCI state), and a second codeword (or a second set of PUSCH transmission layers corresponding to a second codeword) are transmitted via ST×MP using the UL TX spatial filter associated with a second activated/indicated UL TCI state (or joint UL/DL TCI state).

### Embodiment 3: DMRS Ports Indication for Two Codewords

When two codewords are enabled for UL PUSCH transmission towards two TRPs, the number of multiple input multiple output (MIMO) layers for each codeword may also be different and the corresponding DMRS ports for each codeword may be signaled. Assuming that a maximum of 4 layers are supported for the two codewords, the layer combinations are (R1, R2)=(1,1), (1,2), (2,1), (2,2), where R1 and R2 are the number of layers for the first and second codewords, respectively. For type 1 DMRS, up to 4 DMRS ports may be supported with a single front-load symbol. For type 2 DMRS and a single front-load symbol, 6 DMRS ports may be supported. To maintain orthogonality and ease network node channel estimation, DMRS ports associated with different TRPs should be from different CDM groups.

For codeblock (CB) based PUSCH, two “Precoding information” fields, one associated with each TRP or codeword, may be needed in UL scheduling DCI to indicate the precoding matrix for each codeword. For non-CB based PUSCH, two “SRS resource indicator” fields are need in DCI to indicate the SRS resources for each codeword. For both CB and non-CB based PUSCH, a single “Antenna ports” field may be used to jointly indicate the number of layers and DMRS ports for the two codewords. Some examples are shown in Table 1 to Table 4 for different DMRS configurations.

TABLE 1

| | Number of | | | |
|---|---|---|---|---|
| | DMRS CDM | | | |
| | group(s) without | DMRS | Number of front- | |
| Value | data | port(s) | load symbols | (R1, R2) |
| 0 | 2 | 0, 2 | 1 | (1, 1) |
| 1 | 2 | 1, 3 | 1 | (1, 1) |
| 2 | 2 | 0, 1, 2 | 1 | (2, 1) |
| 3 | 2 | 0, 2, 3 | 1 | (1, 2) |
| 4 | 2 | 0, 1, 2, 3 | 1 | (2, 2) |
| 5-7 | Reserved | Reserved | Reserved | |

TABLE 2

| | Number of | | | |
|---|---|---|---|---|
| | DMRS CDM | | | |
| | group(s) without | DMRS | Number of front- | |
| Value | data | port(s) | load symbols | (R1, R2) |
| 0 | 2 | 0, 2 | 1 | (1, 1) |
| 1 | 2 | 1, 3 | 1 | (1, 1) |
| 2 | 2 | 0, 1, 2 | 1 | (2, 1) |
| 3 | 2 | 0, 2, 3 | 1 | (1, 2) |
| 4 | 2 | 0, 1, 2, 3 | 1 | (2, 2) |
| 5 | 2 | 0, 2 | 2 | (1, 1) |
| 6 | 2 | 1, 3 | 2 | (1, 1) |
| 7 | 2 | 0, 1, 2 | 2 | (2, 1) |
| 8 | 2 | 0, 2, 3 | 2 | (1, 2) |
| 9 | 2 | 0, 1, 2, 3 | 2 | (2, 2) |
| 10 | 2 | 4, 6 | 2 | (1, 1) |
| 11 | 2 | 5, 7 | 2 | (1, 1) |
| 12 | 2 | 4, 5, 6 | 2 | (2, 1) |
| 13 | 2 | 4, 6, 7 | 2 | (1, 2) |
| 14 | 2 | 4, 5, 6, 7 | 2 | (2, 2) |
| 15 | Reserved | Reserved | Reserved | |

TABLE 3

| | Number of | | | |
|---|---|---|---|---|
| | DMRS CDM | | | |
| | group(s) without | DMRS | Number of front- | |
| Value | data | port(s) | load symbols | (R1, R2) |
| 0 | 2 | 0, 2 | 1 | (1, 1) |
| 1 | 2 | 1, 3 | 1 | (1, 1) |
| 3 | 2 | 0, 1, 2 | 1 | (2, 1) |
| 4 | 2 | 0, 2, 3 | 1 | (1, 2) |
| 5 | 2 | 0, 1, 2, 3 | 1 | (2, 2) |
| 6 | 3 | 0, 2 | 1 | (1, 1) |
| 7 | 3 | 1, 3 | 1 | (1, 1) |
| 8 | 3 | 0, 1, 2 | 1 | (2, 1) |
| 9 | 3 | 0, 2, 3 | 1 | (1, 2) |
| 10 | 3 | 0, 1, 2, 3 | 1 | (2, 2) |
| 11 | 3 | 1, 4, 5 | 1 | (1, 2) |
| 12 | 3 | 3, 4, 5 | 1 | (1, 2) |
| 13 | 3 | 1, 3, 4, 5 | 1 | (2, 2) |
| 14 | 3 | 0, 2, 4, 5 | 1 | (2, 2) |
| 15 | Reserved | Reserved | Reserved | |

TABLE 4

| | Number of | | | |
|---|---|---|---|---|
| | DMRS CDM | | | |
| | group(s) without | DMRS | Number of front- | |
| Value | data | port(s) | load symbols | (R1, R2) |
| 0 | 2 | 0, 2 | 1 | (1, 1) |
| 1 | 2 | 1, 3 | 1 | (1, 1) |
| 3 | 2 | 0, 1, 2 | 1 | (2, 1) |
| 4 | 2 | 0, 2, 3 | 1 | (1, 2) |
| 5 | 2 | 0, 1, 2, 3 | 1 | (2, 2) |
| 6 | 3 | 0, 2 | 1 | (1, 1) |
| 7 | 3 | 1, 3 | 1 | (1, 1) |
| 8 | 3 | 0, 1, 2 | 1 | (2, 1) |
| 9 | 3 | 0, 2, 3 | 1 | (1, 2) |
| 10 | 3 | 0, 1, 2, 3 | 1 | (2, 2) |
| 11 | 3 | 1, 4, 5 | 1 | (1, 2) |
| 12 | 3 | 3, 4, 5 | 1 | (1, 2) |
| 13 | 3 | 0, 1, 4, 5 | 1 | (2, 2) |
| 14 | 3 | 2, 3, 4, 5 | 1 | (2, 2) |
| 15 | 2 | 0, 2 | 2 | (1, 1) |
| 16 | 2 | 1, 3 | 2 | (1, 1) |
| 17 | 2 | 0, 1, 2 | 2 | (2, 1) |
| 18 | 2 | 0, 2, 3 | 2 | (1, 2) |
| 19 | 2 | 0, 1, 2, 3 | 2 | (2, 2) |
| 20 | 3 | 0, 2 | 2 | (1, 1) |
| 21 | 3 | 1, 3 | 2 | (1, 1) |
| 22 | 3 | 0, 1, 2 | 2 | (2, 1) |
| 23 | 3 | 0, 2, 3 | 2 | (1, 2) |
| 24 | 3 | 0, 1, 2, 3 | 2 | (2, 2) |
| 25 | 3 | 1, 4, 5 | 2 | (1, 2) |
| 26 | 3 | 3, 4, 5 | 2 | (1, 2) |
| 27 | 3 | 0, 1, 4, 5 | 2 | (2, 2) |
| 28 | 3 | 2, 3, 4, 5 | 2 | (2, 2) |
| 29-31 | Reserved | Reserved | Reserved | |

### Embodiment 4: Phase Tracking Reference Signal (PTRS) to DMRS Association

In some embodiments, it may be assumed that the WD 22 is configured for ST×MP using the unified TCI state framework. Furthermore, it may be assumed that the DMRS(s) associated with a first WD 22 panel (TRP/applied UL TCI state) belongs to a first CDM group and that the DMRS(s) associated with a second WD 22 panel (TRP/applied UL TCI state/common beam) belongs to a second DMRS CDM group that is different from the first DMRS group. Some embodiments are described below:

In some embodiments, if a WD 22 is configured with a single PTRS port for uplink (e.g., if the parameter “max NrofPorts” is set to 1 in PTRS-UplinkConfig IE as defined in 3GPP TS 38.311) and configured with a single UL codeword, the existing position TRS to DMRS mapping could be used, i.e., 2 bits in DCI used to indicate one out of up to 4 scheduled DMRS ports; In some embodiments, if a WD 22 is configured with a single PTRS port for uplink (e.g. if the parameter “maxNrofPorts” is set to 1 in PTRS-UplinkConfig IE as defined in 3GPP TS 38.311) and configured with two UL codewords (e.g. by setting a new parameter “maxNrofCodeWordsScheduledByDCIUL” to 2), but the maximum rank (of two codewords) is less than or equal to 4, the existing PTRS to DMRS mapping may be used. If the maximum rank is greater than 4, in one embodiment, 3 bits may be used in DCI to indicate one out of up to 8 scheduled DMRS port to be associated with the PTRS port;

In some embodiments, if a WD 22 is configured with a maximum of two PTRS ports for uplink (e.g. if the parameter “maxNrofPorts” is set to 2 in PTRS-UplinkConfig IE as defined in 3GPP TS 38.311) and configured with either one or two UL codewords, this corresponds to non-codebook based, or partial or non-coherent codebook based, PUSCH transmissions where each UL panel is associated with one of the two PTRS ports. If the maximum rank is less than or equal to 4, the existing PTRS to DMRS mapping may be used, i.e., 2 bits in DCI with the most significant bit (MSB) used to indicate one out of up to 2 scheduled DMRS ports associated with PTRS port 0 in a first panel and the least significant bit (LSB) used to indicate one out of up to 2 scheduled DMRS ports associated with PTRS port 1 in a second panel. Each panel may transmit up to 2 layers. If the maximum rank is greater than 4, and each panel may transmit up to 4 layers, 4 bits in DCI may be used to indicate PTRS to DMRS port association, with the 2 MSB bits used to indicate one out of up to 4 scheduled DMRS ports associated with PTRS port 0 in a first panel and the 2 LSB bits used to indicated one out of up to 4 scheduled DMRS ports associated with PTRS port 1 in a second panel.

In case more than 4 layers are supported, i.e., up to 4 layers per panel, PTRS power boosting in Table 6.2.3.1-3 of 38.214 may be interpreted as per codeword perhaps, as in Table 5.

TABLE 5

| | | The number of PUSCH layers (n_{layer}^{PUSCH}) | | | | | | |
|---|---|---|---|---|---|---|---|---|
| | | 2 | | 3 | | | | |
| | | | Partial | | Partial | 4 | | |
| | | | and non- | | and non- | | | Non- |
| | | | coherent | | coherent | | | coherent |
| UL-PTRS- | 1 | | and non- | | and non- | | | and non- |
| power/ | All | Full | codebook | Full | codebook | Full | Partial | codebook |
| α_{PTRS}^{PUSCH} | cases | coherent | based | coherent | based | coherent | coherent | based |
| 00 | 0 | 3 | 3Qp-3 | 4.77 | 3Qₚ-3 | 6 | 3Qₚ | 3Qₚ-3 |
| 01 | 0 | 3 | 3 | 4.77 | 4.77 | 6 | 6 | 6 |
| 10 | Reserved | | | | | | | |
| 11 | Reserved | | | | | | | |
| | The number of PUSCH layers (n_{layer}^{PUSCH}) per panel, 1 PTRS port per panel | | | | | | | |
| | | 2 | | 3 | | | | |
| | | | Partial | | Partial | 4 | | |
| | | | and non- | | and non- | | | Non- |
| | | | coherent | | coherent | | | coherent |
| | 1 | | and non- | | and non- | | | and non- |
| | All | Full | codebook | Full | codebook | Full | Partial | codebook |
| | cases | coherent | based | coherent | based | coherent | coherent | based |
| 00 | 0 | 3 | 0 | 4.77 | 0 | 6 | 3 | 0 |

| | |
|---|---|
| 01 | Reserved |
| 10 | Reserved |
| 11 | Reserved |

Some non-limiting example embodiments include one or more of the following:

Example 1. A method of simultaneous PUSCH transmission using N=2 DL/UL TCI states (or Joint DL/UL TCI states), the method comprising:

Step 1: Configuring from network to WD 22 a list of DL/UL TCI states (or joint DL/UL TCI states) via higher layer configuration (RRC configuration) to the WD 22;

Step 2: Activating a subset of configured list of DL/UL TCI states (or joint DL/UL TCI states) via MAC CE signaling from the network to the WD 22 where a codepoint in TCI field in a first DCI may be mapped to one or more DL/UL TCI states (or joint DL/UL TCI states);

Step 3: Updating/indicating N=2 DL/UL TCI states (or joint DL/UL TCI states) to a WD 22 from the network via a TCI field codepoint in the first DCI; and

Step 4: using N=2 updated/indicated DL/UL TCI states (or Joint DL/UL TCI states) to transmit a first PUSCH transmission occasion or a first set of PUSCH layers using the first updated/indicated DL/UL TCI state (or Joint DL/UL TCI state), and transmit a second PUSCH transmission occasion or a second set of PUSCH layers using the second updated/indicated DL/UL TCI state (or Joint DL/UL TCI state), wherein the simultaneous transmission is according to one or more of the following:
the transmission corresponding to the first updated/indicated DL/UL TCI state (or Joint DL/UL TCI state) and the transmission corresponding to the second updated/indicated DL/UL TCI state (or Joint DL/UL TCI state) occur in the same one or more symbols in a slot;
the transmission of the first PUSCH transmission occasion corresponding to the first updated/indicated DL/UL TCI state (or Joint DL/UL TCI state) and the transmission of the second PUSCH transmission occasion corresponding to the second updated/indicated DL/UL TCI state (or Joint DL/UL TCI state) occur in different resource blocks within a same symbol in a slot; and/or, the transmission of the first set of PUSCH layers corresponding to the first updated/indicated DL/UL TCI state (or Joint DL/UL TCI state) and the transmission of the second set of PUSCH layers corresponding to the second updated/indicated DL/UL TCI state (or Joint DL/UL TCI state) occur in the same Resource elements.

Example 2. The method of Example 1, for differentiating between simultaneous transmission of PUSCH and other PUSCH transmission schemes, based on a combination of two updated/indicated DL/UL TCI states (or joint DL/UL TCI states) and one or more of:
RRC configuration indicating whether the WD 22 shall perform simultaneous transmission of PUSCH using the two updated/indicated DL/UL TCI states (or joint DL/UL TCI states) or the WD 22 shall perform PUSCH transmission according to one of the other PUSCH transmission schemes,
the number of CDM groups indicated in the antenna Port bit field in scheduling UL DCI
an explicit indication in a dedicated bit field in scheduling UL DCI

Example 3. The method of any of Examples 1 and 2, wherein a first codeword (or transmission layers associated with the first codeword) are transmitted using the first of two updated/indicated DL/UL TCI states (or joint DL/UL TCI states), and a second codeword (or transmission layers associated with the second codeword) are transmitted using the second of two updated/indicated DL/UL TCI states (or joint DL/UL TCI states) where:
one or more of a first MCS field in scheduling UL DCI, a first new data indicator field in scheduling UL DCI, and a first redundancy version field in scheduling UL DCI are associated with the transmission corresponding to the first of two updated/indicated DL/UL TCI states (or joint DL/UL TCI states); and/or
one or more of a second MCS field in scheduling UL DCI, a second new data indicator field in scheduling UL DCI, and a second redundancy version field in scheduling UL DCI are associated with the transmission corresponding to the second of two updated/indicated DL/UL TCI states (or joint DL/UL TCI states).

Example 4. The method of Example 3, wherein the uplink DM-RS ports indicated in the UL scheduling DCI corresponding to the transmission associated with the first of two updated/indicated DL/UL TCI states (or joint DL/UL TCI states) belongs to a first CDM group, and the uplink DM-RS ports indicated in the UL scheduling DCI corresponding to the transmission associated with the second of two updated/indicated DL/UL TCI states (or joint DL/UL TCI states) belongs to a second CDM group, wherein the first and the second CDM groups are different CDM groups.

Example 5. The method of Example 3, wherein a first precoding information field indicated in the UL scheduling DCI corresponds to the transmission associated with the first of two updated/indicated DL/UL TCI states (or joint DL/UL TCI states), and a second precoding information field indicated in the UL scheduling DCI corresponds to the transmission associated with the second of two updated/indicated DL/UL TCI states (or joint DL/UL TCI states).

Example 6. The method of Example 3, wherein a SRS resource indicator field indicated in the UL scheduling DCI corresponds to the transmission associated with the first of two updated/indicated UL TCI states (or joint DL/UL TCI states), and a second SRS resource indicator field indicated in the UL scheduling DCI corresponds to the transmission associated with the second of two updated/indicated DL/UL TCI states (or joint DL/UL TCI states).

According to one aspect, a network node 16 is configured to communicate with a wireless device (WD). The network node 16 includes a radio interface 62 and/or processing circuitry 68 configured to indicate to the WD 22 a pair of activated uplink, UL, transmission configuration indicator, TCI, states for one of a plurality of multi-transmission reception point, multi-TRP, physical uplink shared channel, PUSCH, transmission schemes.

According to this aspect, in some embodiments, the network node 16, radio interface 62 and/or processing circuitry 68 is configured to one of implicitly and explicitly indicate to the WD 22 which one of the plurality of multi-TRP PUSCH transmission schemes is to be used by the WD 22. In some embodiments, the network node 16, radio interface 62 and/or processing circuitry 68 is configured to indicate to the WD 22 an antenna panel to use for transmission. In some embodiments, the network node 16, radio interface 62 and/or processing circuitry 68 is configured to indicate to the WD 22 which two of a plurality of codewords to be used for uplink transmission. In some embodiments, the network node 16, radio interface 62 and/or processing circuitry 68 is configured to indicate to the WD 22 a precoding matrix for each codeword.

According to another aspect, method implemented in a network node 16 includes indicating to the WD 22 a pair of activated uplink, UL, transmission configuration indicator, TCI, states for one of a plurality of multi-transmission reception point, multi-TRP, physical uplink shared channel, PUSCH, transmission schemes.

According to this aspect, in some embodiments, the method further includes one of implicitly and explicitly indicating to the WD 22 which one of the plurality of multi-TRP PUSCH transmission schemes is to be used by the WD 22. In some embodiments, the method further includes indicating to the WD 22 an antenna panel to use for transmission. In some embodiments, the method further includes indicating to the WD 22 which two of a plurality of codewords to be used for uplink transmission. In some embodiments, the method further includes indicating to the WD 22 a precoding matrix for each codeword.

According to yet another aspect, a WD 22 configured to communicate with a network node 16 is provided. The WD 22 includes a radio interface 82 and/or processing circuitry 84 configured to determine one of a plurality of multi-transmission reception point, multi-TRP, physical uplink shared channel, PUSCH, transmission schemes based on a pair of activated uplink, UL, transmission configuration indicator, TCI, states indicated by the network node 16.

According to this aspect, in some embodiments, the WD 22, radio interface 82 and/or processing circuitry 84 are further configured to select one of the plurality of multi-TRP PUSCH transmission schemes based on an indication form the network node 16. In some embodiments, the WD 22, radio interface 82 and/or processing circuitry 84 are further configured to select an antenna panel for transmission based on an indication from the network node 16. In some embodiments, the WD 22, radio interface 82 and/or processing circuitry 84 are further configured to select one of a plurality of codewords for uplink transmission. In some embodiments, the WD 22, radio interface 82 and/or processing circuitry 84 are further configured to select a precoding matrix for each codeword.

According to another aspect, a method implemented in a wireless device (WD) includes determining one of a plurality of multi-transmission reception point, multi-TRP, physical uplink shared channel, PUSCH, transmission schemes based on a pair of activated uplink, UL, transmission configuration indicator, TCI, states indicated by the network node 16.

According to this aspect, in some embodiments, the method further includes selecting one of the plurality of multi-TRP PUSCH transmission schemes based on an indication form the network node 16. In some embodiments, the method further includes selecting an antenna panel for transmission based on an indication from the network node 16. In some embodiments, the method further includes selecting one of a plurality of codewords for uplink transmission. In some embodiments, the method also includes selecting a precoding matrix for each codeword.

Some embodiments may include one or more of the following:

Embodiment A1. A network node configured to communicate with a wireless device (WD), the network node configured to, and/or comprising a radio interface and/or comprising processing circuitry configured to:

indicate to the WD a pair of activated uplink, UL, transmission configuration indicator, TCI, states for one of a plurality of multi-transmission reception point, multi-TRP, physical uplink shared channel, PUSCH, transmission schemes.

Embodiment A2. The network node of Embodiment A1, wherein the network node, radio interface and/or processing circuitry are further configured to one of implicitly and explicitly indicate to the WD which one of the plurality of multi-TRP PUSCH transmission schemes is to be used by the WD.

Embodiment A3. The network node of any of Embodiments A1 and A2, wherein the network node, radio interface and/or processing circuitry are further configured to indicate to the WD an antenna panel to use for transmission.

Embodiment A4. The network node of any of Embodiments A1-A3, wherein the network node, radio interface and/or processing circuitry are further configured to indicate to the WD which two of a plurality of codewords to be used for uplink transmission.

Embodiment A5. The network node of Embodiment A4, wherein the network node, radio interface and/or processing circuitry are further configured to indicate to the WD a precoding matrix for each codeword.

Embodiment B1. A method implemented in a network node, the method comprising:

indicating to the WD a pair of activated uplink, UL, transmission configuration indicator, TCI, states for one of a plurality of multi-transmission reception point, multi-TRP, physical uplink shared channel, PUSCH, transmission schemes.

Embodiment B2. The method of Embodiment B1, further comprising one of implicitly and explicitly indicating to the WD which one of the plurality of multi-TRP PUSCH transmission schemes is to be used by the WD.

Embodiment B3. The method of any of Embodiments B1 and B2, further comprising indicating to the WD an antenna panel to use for transmission.

Embodiment B4. The method of any of Embodiments B1-B3, further comprising indicating to the WD which two of a plurality of codewords to be used for uplink transmission.

Embodiment B5. The method of Embodiment B4, further comprising indicating to the WD a precoding matrix for each codeword.

Embodiment C1. A wireless device (WD) configured to communicate with a network node, the WD configured to, and/or comprising a radio interface and/or processing circuitry configured to:

determine one of a plurality of multi-transmission reception point, multi-TRP, physical uplink shared channel, PUSCH, transmission schemes based on a pair of activated uplink, UL, transmission configuration indicator, TCI, states indicated by the network node.

Embodiment C2. The WD of Embodiment C1, wherein the WD, radio interface and/or processing circuitry are further configured to select one of the plurality of multi-TRP PUSCH transmission schemes based on an indication form the network node.

Embodiment C3. The WD of any of Embodiments C1 and C2, wherein the WD, radio interface and/or processing circuitry are further configured to select an antenna panel for transmission based on an indication from the network node.

Embodiment C4. The WD of any of Embodiments C1-C3, wherein the WD, radio interface and/or processing circuitry are further configured to select one of a plurality of codewords for uplink transmission.

Embodiment C5. The WD of Embodiment C4, wherein the WD, radio interface and/or processing circuitry are further configured to select a precoding matrix for each codeword.

Embodiment D1. A method implemented in a wireless device (WD), the method comprising:
determining one of a plurality of multi-transmission reception point, multi-TRP, physical uplink shared channel, PUSCH, transmission schemes based on a pair of activated uplink, UL, transmission configuration indicator, TCI, states indicated by the network node.

Embodiment D2. The method of Embodiment D1, further comprising selecting one of the plurality of multi-TRP PUSCH transmission schemes based on an indication form the network node.

Embodiment D3. The method of any of Embodiments D1 and D2, further comprising selecting an antenna panel for transmission based on an indication from the network node.

Embodiment D4. The method of any of Embodiments D1-D3, further comprising selecting one of a plurality of codewords for uplink transmission.

Embodiment D5. The method of Embodiment D4, further comprising selecting a precoding matrix for each codeword.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A network node (16) configured to communicate with a wireless device, WD (22), the network node (16) comprising:
processing circuitry (68) configured to configure the WD (22) with at least two transmission configuration indicator, TCI, states; and
a radio interface (62) in communication with the processing circuitry (68) and configured to:
transmit downlink control information, fDCI, comprising an indication of a first TCI state and a second TCI state to be activated by the WD (22); and
receive a first physical uplink shared channel, PUSCH, transmission occasion or a first set of PUSCH layers transmitted using a first spatial filter associated with the first TCI state, and receive a second PUSCH transmission occasion or a second set of PUSCH layers transmitted using a second spatial filter associated with the second TCI state.

2. The network node (16) of claim 1, wherein the indication is carried by a codepoint of a TCI field in the DCI.

3. The network node (16) of claim 1, wherein the first and second TCI states are one of (a) a first and second Joint/DL TCI states, respectively, and (b) a first and a second UL TCI states, respectively.

4. The network node (16) of any of claims 1-3, wherein the DCI further includes an indication of simultaneous transmission of at least one of the first PUSCH occasion, the first set of PUSCH layers and the second PUSCH occasion, and the second set of PUSCH layers.

5. The network node (16) of any of claims 1-4, wherein the DCI further comprises an indication of a set of demodulation reference signal, DRMS, ports associated to the simultaneous transmission.

6. The network node (16) of claim 5, wherein the set of DMRS ports includes at least one of a first subset DMRS ports associated to at least one of the first PUSCH transmissions and the first set of PUSCH layers and a second subset of DMRS ports associated to at least one of the second PUSCH transmissions and the first and the second set of PUSCH layers.

7. The network node (16) of any of claims 5 and 6, wherein the indication of the set of DMRS ports implicitly indicates at least one of a first number of layers associated to at least one of the first PUSCH transmissions and the first set of PUSCH layers, and a second number of layers associated to at least one of the second PUSCH transmissions and the first and the second set of PUSCH layers.

8. The network node (16) of any of claims 4-7, wherein the simultaneous transmission is implicitly indicated when the first subset of DMRS ports are in a first code division multiplex, CDM, group and the second subset of DMRS ports are in a second CDM group, wherein the first and second CDM groups are different.

9. The network node (16) of any of claims 4-8, wherein the simultaneous transmission is explicitly indicated by a codepoint of a bitfield in the DCI.

10. The network node (16) of any of claims 4-9, wherein the simultaneous transmission is indicated by a Radio Resource Control, RRC, message.

11. The network node (16) of any of claims 1-10, wherein the DCI further comprises first precoding information associated with at least one of the first PUSCH transmission occasion and transmission of the first set of PUSCH layers, and second precoding information associated with at least one of the second PUSCH transmission occasion and transmission of the second set of PUSCH layers.

12. The network node (16) of any of claims 1-11, wherein the DCI further comprises a first sounding reference signal, SRS, resource indicator associated with at least one of the first PUSCH transmission occasion and transmission of the first set of PUSCH layers, and a second SRS resource indicator associated with at least one of the second PUSCH transmission occasion and transmission of the second set of PUSCH layers.

13. The network node (16) of any of claims 11-12, wherein one of a first codeword and transmission layers associated with the first codeword are transmitted using a first of two indicated TCI states, and one of a second codeword and transmission layers associated with the second codeword are transmitted using a second of the two indicated TCI states.

14. The network node (16) of claim 13, wherein at least one of a first modulation and coding scheme, MCS, field in scheduling uplink DCI, a first new data indicator field in the scheduling uplink DCI and a first redundancy version field in the scheduling uplink DCI is associated with a transmission corresponding to the first of the two indicated TCI states.

15. The network node (16) of any of claims 13 and 14, wherein at least one of a second modulation and coding scheme, MCS, field in scheduling uplink DCI, a second new data indicator field in the scheduling uplink DCI and a second redundancy version field in the scheduling uplink DCI is associated with a transmission corresponding to the to the second of the two indicated TCI states.

16. The network node (16) of any of claims 11-15, wherein the DCI further comprises information about a first DMRS port associated to a first phase tracking reference signal, PTRS, and information about a second DMRS port associated to a second PTRS, wherein the first DMRS port and the first PTRS are associated to the first PUSCH transmission and the second DMRS port and the second PTRS are associated to the first PUSCH transmission, and wherein the first and second DMRS ports are in the first and second code division multiplex, CDM, groups, respectively, and belong to the set of DMRS ports.

17. A method in a network node (16) configured to communicate with a wireless device, WD (22), the method comprising:
configuring (S138) the WD (22) with at least two transmission configuration indicator, TCI, states;
transmitting (S140) downlink control information, DCI, comprising an indication of a first TCI state and a second TCI state to be activated by the WD (22); and
receiving (S142) a first physical uplink shared channel, PUSCH, transmission occasion or a first set of PUSCH layers transmitted using a first spatial filter associated with the first TCI state, and receiving a second PUSCH transmission occasion or a second set of PUSCH layers transmitted using a second spatial filter associated with the second TCI state.

18. The method of claim 17, wherein the indication is carried by a codepoint of a TCI field in the DCI.

19. The method of claim 17, wherein the first and second TCI states are one of (a) a first and second Joint/DL TCI states, respectively, and (b) a first and a second UL TCI states, respectively.

20. The method of any of claims 17-19, wherein the DCI further includes an indication of simultaneous transmission of at least one of the first PUSCH occasion, the first set of PUSCH layers and the second PUSCH occasion, and the second set of PUSCH layers.

21. The method of any of claims 17-20, wherein the DCI further comprises an indication of a set of demodulation reference signal, DRMS, ports associated to the simultaneous transmission.

22. The method of claim 21, wherein the set of DMRS ports includes at least one of a first subset DMRS ports associated to at least one of the first PUSCH transmissions and the first set of PUSCH layers and a second subset of DMRS ports associated to at least one of the second PUSCH transmissions and the first and the second set of PUSCH layers.

23. The method of any of claims 21 and 22, wherein the indication of the set of DMRS ports implicitly indicates at least one of a first number of layers associated to at least one of the first PUSCH transmissions and the first set of PUSCH layers, and a second number of layers associated to at least one of the second PUSCH transmissions and the first and the second set of PUSCH layers.

24. The method of any of claims 20-23, wherein the simultaneous transmission is implicitly indicated when the first subset of DMRS ports are in a first code division multiplex, CDM, group and the second subset of DMRS ports are in a second CDM group, wherein the first and second CDM groups are different.

25. The method of any of claims 20-24, wherein the simultaneous transmission is explicitly indicated by a codepoint of a bitfield in the DCI.

26. The method of any of claims 20-25, wherein the simultaneous transmission is indicated by a Radio Resource Control, RRC, message.

27. The method of any of claims 17-26, wherein the DCI further comprises first precoding information associated with at least one of the first PUSCH transmission occasion and transmission of the first set of PUSCH layers, and second precoding information associated with at least one of the second PUSCH transmission occasion and transmission of the second set of PUSCH layers.

28. The method of any of claims 17-27, wherein the DCI further comprises a first sounding reference signal, SRS, resource indicator associated with at least one of the first PUSCH transmission occasion and transmission of the first set of PUSCH layers, and a second SRS resource indicator associated with at least one of the second PUSCH transmission occasion and transmission of the second set of PUSCH layers.

29. The method of any of claims 17-28, wherein one of a first codeword and transmission layers associated with the first codeword are transmitted using a first of two indicated TCI states, and one of a second codeword and transmission layers associated with the second codeword are transmitted using a second of the two indicated TCI states.

30. The method of claim 29, wherein at least one of a first modulation and coding scheme, MCS, field in scheduling uplink DCI, a first new data indicator field in the scheduling uplink DCI and a first redundancy version field in the scheduling uplink DCI is associated with a transmission corresponding to the first of the two indicated TCI states.

31. The method of any of claims 29 and 30, wherein at least one of a second modulation and coding scheme, MCS, field in scheduling uplink DCI, a second new data indicator field in the scheduling uplink DCI and a second redundancy version field in the scheduling uplink DCI is associated with a transmission corresponding to the to the second of the two indicated TCI states.

32. The method of any of claims 17-31, wherein the DCI further comprises information about a first DMRS port associated to a first phase tracking reference signal, PTRS, and information about a second DMRS port associated to a second PTRS, wherein the first DMRS port and the first PTRS are associated to the first PUSCH transmission and the second DMRS port and the second PTRS are associated to the first PUSCH transmission, and wherein the first and second DMRS ports are in the first and second code division multiplex, CDM, groups, respectively, and belong to the set of DMRS ports.

33. A wireless device, WD (22), configured to communicate with a network node (16), the WD (22) comprising:
a radio interface (82) configured to:
receive from the network node (16) a Downlink Control Information, DCI, comprising an indication that indicates a first and second TCI state; and
transmit one of a first physical uplink shared channel, PUSCH, transmission occasion and a first set of PUSCH layers using a first spatial filter associated with the first TCI state, and transmit one of a second PUSCH transmission occasion and a second set of PUSCH layers using a second spatial filter associated with the second TCI state.

34. The WD (22) of claim 33, wherein the indication is carried by a codepoint of a TCI field in the DCI.

35. The WD (22) of claim 33, wherein the first and second TCI states are one of (a) a first and second Joint/DL TCI states, respectively, and (b) a first and a second UL TCI states, respectively.

36. The WD (22) of any of claims 33-35, wherein the received DCI further includes an indication of simultaneous transmission of at least one of the first PUSCH occasion, the first set of PUSCH layers and the second PUSCH occasion, and the second set of PUSCH layers.

37. The WD (22) of any of claims 33-36, wherein the received DCI further comprises an indication of a set of demodulation reference signal, DRMS, ports associated to the simultaneous transmission.

38. The WD (22) of claim 37, wherein the set of DMRS ports includes at least one of a first subset DMRS ports associated to at least one of the first PUSCH transmissions and the first set of PUSCH layers and a second subset of DMRS ports associated to at least one of the second PUSCH transmissions and the first and the second set of PUSCH layers.

39. The WD (22) of any of claims 37 and 38, wherein the indication of the set of DMRS ports implicitly indicates at least one of a first number of layers associated to at least one of the first PUSCH transmissions and the first set of PUSCH layers, and a second number of layers associated to at least one of the second PUSCH transmissions and the first and the second set of PUSCH layers.

40. The WD (22) of any of claims 36-39, wherein the simultaneous transmission is implicitly indicated when the first subset of DMRS ports are in a first code division multiplex, CDM, group and the second subset of DMRS ports are in a second CDM group, wherein the first and second CDM groups are different.

41. The WD (22) of any of claims 36-40, wherein the simultaneous transmission is explicitly indicated by a codepoint of a bitfield in the DCI.

42. The WD (22) of any of claims 36-41, wherein the simultaneous transmission is indicated by a Radio Resource Control, RRC, message.

43. The WD (22) of any of claims 33-42, wherein the DCI further comprises first precoding information associated with at least one of the first PUSCH transmission occasion and transmission of the first set of PUSCH layers, and second precoding information associated with at least one of the second PUSCH transmission occasion and transmission of the second set of PUSCH layers.

44. The WD (22) of any of claims 33-43, wherein the DCI further comprises a first sounding reference signal, SRS, resource indicator associated with at least one of the first PUSCH transmission occasion and transmission of the first set of PUSCH layers, and a second SRS resource indicator associated with at least one of the second PUSCH transmission occasion and transmission of the second set of PUSCH layers.

45. The WD (22) of any of claims 33-44, wherein one of a first codeword and transmission layers associated with the first codeword are transmitted using a first of two indicated TCI states, and one of a second codeword and transmission layers associated with the second codeword are transmitted using a second of the two indicated TCI states.

46. The WD (22) of claim 45, wherein at least one of a first modulation and coding scheme, MCS, field in scheduling uplink DCI, a first new data indicator field in the scheduling uplink DCI and a first redundancy version field in the scheduling uplink DCI is associated with a transmission corresponding to the first of the two indicated TCI states.

47. The WD (22) of any of claims 45 and 46, wherein at least one of a second modulation and coding scheme, MCS, field in scheduling uplink DCI, a second new data indicator field in the scheduling uplink DCI and a second redundancy version field in the scheduling uplink DCI is associated with a transmission corresponding to the to the second of the two indicated TCI states.

48. The WD (22) of any of claims 33-47, wherein the DCI further comprises information about a first DMRS port associated to a first phase tracking reference signal, PTRS, and information about a second DMRS port associated to a second PTRS, wherein the first DMRS port and the first PTRS are associated to the first PUSCH transmission and the second DMRS port and the second PTRS are associated to the first PUSCH transmission, and wherein the first and second DMRS ports are in the first and second code division multiplex, CDM, groups, respectively, and belong to the set of DMRS ports.

49. A method in a wireless device, WD (22), configured to communicate with a network node (16), the method comprising:
receiving (S144) from the network node (16) a Downlink Control Information, DCI, comprising an indication that indicates a first and second TCI state; and
transmitting (S146) one of a first physical uplink shared channel, PUSCH, transmission occasion and a first set of PUSCH layers using a first spatial filter associated with the first TCI state, and transmit one of a second PUSCH transmission occasion and a second set of PUSCH layers using a second spatial filter associated with the second TCI state.

50. The method of claim 49, wherein the indication is carried by a codepoint of a TCI field in the DCI.

51. The method of claim 49, wherein the first and second TCI states are one of (a) a first and second Joint/DL TCI states, respectively, and (b) a first and a second UL TCI states, respectively.

52. The method of any of claims 49-51, wherein the received DCI further includes an indication of simultaneous transmission of at least one of the first PUSCH occasion, the first set of PUSCH layers and the second PUSCH occasion, and the second set of PUSCH layers.

53. The method of any of claims 49-52, wherein the received DCI further comprises an indication of a set of demodulation reference signal, DRMS, ports associated to the simultaneous transmission.

54. The method of claim 53, wherein the set of DMRS ports includes at least one of a first subset DMRS ports associated to at least one of the first PUSCH transmissions and the first set of PUSCH layers and a second subset of DMRS ports associated to at least one of the second PUSCH transmissions and the first and the second set of PUSCH layers.

55. The method of any of claims 53 and 54, wherein the indication of the set of DMRS ports implicitly indicates at least one of a first number of layers associated to at least one of the first PUSCH transmissions and the first set of PUSCH layers, and a second number of layers associated to at least one of the second PUSCH transmissions and the first and the second set of PUSCH layers.

56. The method of any of claims 52-55, wherein the simultaneous transmission is implicitly indicated when the first subset of DMRS ports are in a first code division multiplex, CDM, group and the second subset of DMRS ports are in a second CDM group, wherein the first and second CDM groups are different.

57. The method of any of claims 52-56, wherein the simultaneous transmission is explicitly indicated by a codepoint of a bitfield in the DCI.

58. The method of any of claims 52-57, wherein the simultaneous transmission is indicated by a Radio Resource Control, RRC, message.

59. The method of any of claims 49-58, wherein the DCI further comprises first precoding information associated with at least one of the first PUSCH transmission occasion and transmission of the first set of PUSCH layers, and second precoding information associated with at least one of the second PUSCH transmission occasion and transmission of the second set of PUSCH layers.

60. The method of any of claims 49-59, wherein the DCI further comprises a first sounding reference signal, SRS, resource indicator associated with at least one of the first PUSCH transmission occasion and transmission of the first set of PUSCH layers, and a second SRS resource indicator associated with at least one of the second PUSCH transmission occasion and transmission of the second set of PUSCH layers.

61. The method of any of claims 49-60, wherein one of a first codeword and transmission layers associated with the first codeword are transmitted using a first of two indicated TCI states, and one of a second codeword and transmission layers associated with the second codeword are transmitted using a second of the two indicated TCI states.

62. The method of claim 61, wherein at least one of a first modulation and coding scheme, MCS, field in scheduling uplink DCI, a first new data indicator field in the scheduling uplink DCI and a first redundancy version field in the scheduling uplink DCI is associated with a transmission corresponding to the to the first of the two indicated TCI states.

63. The method of any of claims 61 and 62, wherein at least one of a second modulation and coding scheme, MCS, field in scheduling uplink DCI, a second new data indicator field in the scheduling uplink DCI and a second redundancy version field in the scheduling uplink DCI is associated with a transmission corresponding to the to the second of the two indicated TCI states.

64. The method of any of claims 49-63, wherein the DCI further comprises information about a first demodulation reference signal, DMRS, port associated to a first phase tracking reference signal, PTRS, and information about a second DMRS port associated to a second PTRS, wherein the first DMRS port and the first PTRS are associated to the first PUSCH transmission and the second DMRS port and the second PTRS are associated to the first PUSCH transmission, and wherein the first and second DMRS ports are in the first and second code division multiplex, CDM, groups, respectively, and belong to the set of DMRS ports.
